(19) United States
(12) Patent Application Publication
(10) Pub. No.: US 2011/0107431 A1
(43) Pub. Date: May 5, 2011

(54) METHOD AND APPARATUS FOR PROTECTING AN EMBEDDED CONTENT OBJECT

(75) Inventor: Jarri Pekka Sukanen, Espoo (FI)

(73) Assignee: Nokia Corporation, Espoo (FI)

(21) Appl. No.: 12/609,371

(22) Filed: Oct. 30, 2009

(51) Int. Cl. G06F 17/30; G06F 3/048

(52) U.S. Cl. 726/27; 715/764

(57) ABSTRACT

An approach is provided for protecting an embedded content object. A content object binding manager receives a request, from a user, for a content object. In response to the request, the binding manager causes, at least in part, actions that result in transmission of the content object including an unassociated binding key to the user. The user may embed the content object in a displayable medium. The binding manager then detects a first access of the content object in the displayable medium at a host and binds the content object to the host using the unassociated binding key in response to the detection.

### BACKGROUND

Service providers and device manufacturers are continually challenged to deliver value and convenience to consumers by, for example, providing compelling network services and advancing the underlying technologies. One area of interest has been the development of services and technologies for sharing content (e.g., music) and related information particularly in a social networking environment. In particular, these technologies include the development of easily redistributable software content objects for content and/or information sharing. However, because the majority of social networking environments are web-based and external to the content service, service providers and device manufacturers face significant technical challenges to providing user-friendly means for protecting (e.g., limiting distribution of or access to) these content objects in an open environment (e.g., the Internet).

### Some Example Embodiments

Therefore, there is a need for an approach for automatically and efficiently protecting embedded software content objects.

According to one embodiment, a method comprises receiving a request, from a device, for a content object embedding code. The method also comprises, in response to the request, causing, at least in part, actions that result in transmission of the content object embedding code including an unassociated binding key to the device. The content object embedding code is embedded at a host. The method further comprises detecting a first access of a content object corresponding to the content object embedding code at the host. The method further comprises binding the content object to the host using the unassociated binding key in response to the detection.

According to another embodiment, an apparatus comprising at least one processor, and at least one memory including computer program code, the at least one memory and the computer program code configured to, with the at least one processor, cause, at least in part, the apparatus to receive a request, from a device, for a content object embedding code. The apparatus is also causes, in response to the request, actions that result in transmission of the content object embedding code including an unassociated binding key to the device. The content object embedding code is embedded at a host. The apparatus is further caused to detect a first access of a content object corresponding to the content object embedding code at the host. The apparatus further caused to bind the content object to the host using the unassociated binding key in response to the detection.

According to another embodiment, a computer-readable storage medium carrying one or more sequences of one or more instructions which, when executed by one or more processors, cause, at least in part, an apparatus to receive a request, from a device, for a content object embedding code. The apparatus is also causes, in response to the request, actions that result in transmission of the content object embedding code including an unassociated binding key to the device. The content object embedding code is embedded at a host. The apparatus is further caused to detect a first access of a content object corresponding to the content object embedding code at the host. The apparatus further caused to bind the content object to the host using the unassociated binding key in response to the detection.

According to another embodiment, an apparatus comprises means for receiving a request, from a device, for a content object embedding code. The apparatus also comprises, in response to the request, means for causing, at least in part, actions that result in transmission of the content object embedding code including an unassociated binding key to the device. The content object embedding code is embedded at a host. The apparatus further comprises means for detecting a first access of a content object corresponding to the content object embedding code at the host. The apparatus further comprises means for binding the content object to the host using the unassociated binding key in response to the detection.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of customizing an embedded content object, according to one embodiment;

FIG. 2 is a diagram of the components of a content object binding manager, according to one embodiment;

FIG. 3 a diagram of a content object, according to one embodiment;

FIG. 4 is a flowchart of a process for binding a content object to a host using an unassociated binding key, according to one embodiment;

FIG. 5 is a flowchart of a process for protecting access to data of a content object using a binding key, according to one embodiment;

FIG. 6 is a flowchart of a process for removing the binding between a host and a content object, according to one embodiment;

FIG. 7 is a time sequence diagram that illustrates a sequence of messages and processes for binding a content object to a host using an unassociated binding key, according to one embodiment;

FIG. 8 is a time sequence diagram that illustrates a sequence of messages and processes for protecting access to data of a content object using a binding key; according to one embodiment;

FIG. 9 is a flowchart of a process for customizing a content object based on a viewer of the content object, according to one embodiment;

FIG. 10 is a flowchart of a process for customizing a content object based on the status of an owner of the content object, according to one embodiment;

FIGS. 11A-11B are time sequence diagrams that illustrate a sequence of messages and processes for customizing a content object based on a viewer of the content object, according to various embodiments;

FIG. 12 is a time sequence diagram that illustrates a sequence of messages and processes for customizing a content object based on the status of the owner of the content object, according to one embodiment;

FIG. 13 is a diagram of components of a service, according to one embodiment;

FIG. 14 is a diagram of an example web page with multiple content objects embedded thereon, according to an embodiment;

FIG. 15 is a flowchart of a process in a web server to use content objects, according to one embodiment;

FIG. 16 is a flowchart of a process at a content object or content object service to provide and render shared content, according to one embodiment;

FIG. 17 is a diagram of hardware that can be used to implement an embodiment of the invention;

FIG. 18 is a diagram of a chip set that can be used to implement an embodiment of the invention; and

FIG. 19 is a diagram of a mobile terminal (e.g., a handset) that can be used to implement an embodiment of the invention.

### DESCRIPTION OF SOME EMBODIMENTS

Examples of a method, apparatus, and computer program for protecting an embedded content object are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, a content object is a software object that can be embedded in a displayable medium (e.g., web page, email message, short message service (SMS) message, multimedia messaging service (MMS) message, instant messaging session, etc.) for presentation to one or more users. Software objects are self-contained collections of data and methods and used, for example, in object-oriented programming (OOP). In some embodiments, a content object provides a graphical user interface (GUI). In other embodiments, a content object is also known as a content locket. Additionally, in certain embodiments, a widget may also be a content object. By way of example, widgets are light-weight applications based on standard web technologies (e.g., web runtime (WRT)—a web application runtime environment included in many browsers), that serve as frontends or clients to web-based or other content. Content objects provide a convenient means for presenting information and accessing services.

Although several embodiments of the invention are discussed with respect to music sharing using a web browser containing one or more embedded content objects, it is recognized by one of ordinary skill in the art that the embodiments of the inventions have applicability to any type of content rendering, e.g., music or video playback or streaming, games playing, image or map displaying, radio or television content broadcasting or streaming, involving any device, e.g., wired and wireless local device or both local and remote wired or wireless devices, capable of rendering content, or capable of communication with such a device, using any application that allows objects to be embedded, such a standard web browser, a standard email client, a standard instant messaging client, and a standard file transfer protocol (FTP) client. As used herein, content or media includes, for example, digital sound, songs, digital images, digital games, digital maps, point of interest information, digital videos, such as music videos, news clips and theatrical videos, advertisements, program files or objects, any other digital media or content, or any combination thereof. The term rendering indicates any method for presenting the content to a human user, including playing music through speakers, displaying images on a screen or in a projection or on tangible media such as photographic or plain paper, showing videos on a suitable display device with sound, graphing game or map data, or any other term of art for presentation, or any combination thereof. In many illustrated embodiments, a player is an example of a rendering module. A playlist is information about content rendered on one or more players in response to input by a user, and is associated with that user. A play history is information about the time sequence of content rendered on one or more players in response to input by a user, and is associated with that user.

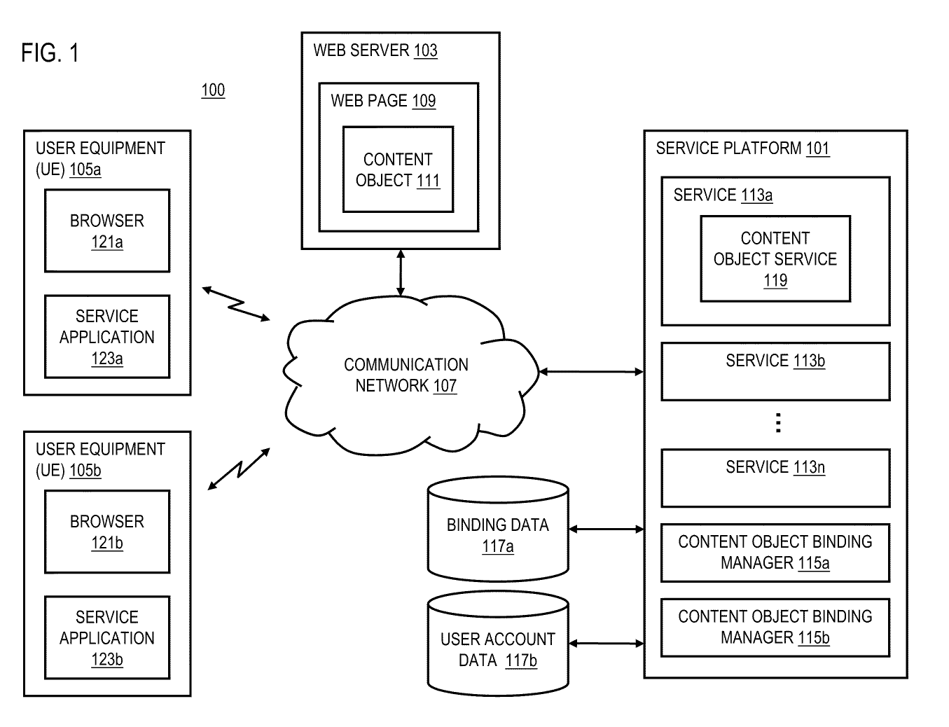

FIG. 1 is a diagram of a system capable of protecting an embedded content object, according to one embodiment. A key technical advantage of content objects is that they are portable and easily distributable from one medium (e.g., a web page) to another medium (e.g., an email message) using standard web technologies (e.g., HTML code, Adobe Flash, etc.). In many cases, the user need only copy and paste the code or embedding code for the content object in order to transfer the content object. For example, a social music service provides music content objects that users can embed in other web sites to display the users' musical preferences. For instance, to embed the content object in a personal web page (e.g., a user's social networking web page), the user need only copy and paste the corresponding code for the content object into the code of the receiving web page. Historically, there has been no limitation on who can copy or distribute a content object. In other words, once a content object is placed on a web page, any viewer of that web page can copy and paste the content object to any other web page or displayable medium.

Traditionally, services that provide embeddable content objects and want to protect, control, or otherwise limit the distribution of such content objects have relied on the use of binding keys. As is well known in the art, binding keys enable services to uniquely relate one item to any other item. For example, in the context of a content object, a user typically manually requests a binding key from the service provider by specifying the host at which the content object will be embedded. The service will then provide a binding key for the user to manually insert into the embedding code of the content object. In practice, however, this process makes it complex and cumbersome for a user (particularly those with limited technical knowledge) to use binding keys to protect their content objects. As a result, most users proceed without protection against unwanted distribution of or access to the users' content objects.

In addition, because most content objects have limited protection, users traditionally have had very little control over the use of the content objects once the content objects have been distributed. For example, to remove or disable a content object, a user would have to remember or note all locations in which the content object has been embedded. Then the user would have to modify the code at the embedded locations to remove the content object. Again, this process is of removing content objects from embedded sites can be quite cumbersome, thereby discouraging or preventing users from revoking content objects even if the user no longer wanted the content objects to be available.

To address the problems described above, the system 100 of FIG. 1 introduces the capability to generate a binding key that can be used to automatically bind a content object to a specific host without prior knowledge of the host or extensive manual input. For example, in the approach described herein, the system 100 generates a binding key that is unassociated with a host. The system 100 then includes the unassociated binding key with the embedding code associated with a content object and provides this code to the user. The user can then incorporate the embedding code into, for instance, a web page. When the web page is first accessed, the system 100 automatically binds the web page host to the content object using the unassociated binding key. In this way, the system 100 advantageously reduces the number steps the user takes to protect a content object as well as the need to know the specific host name before generating a binding key. In addition, by storing information on hosts that are bound to particular content objects, the system 100 introduces the capability to manage (e.g., unbind, modify, view, etc.) bound hosts without manual tracking by the user.

As shown in FIG. 1, the system 100 includes a service platform 101 with connectivity to a web server 103 and user equipment (UE) 105a-105b over the communication network 107. For the sake of simplicity, FIG. 1 depicts only two UEs (e.g., UEs 105a-105n) in the system 100. However, it is contemplated that the system may support any number of UEs 105 up to the maximum capacity of the communication network 107. For example, the network capacity may be determined based on available bandwidth, available connection points, and/or the like. The web server 103 further includes one or more web pages 109 including one or more content objects 111 to facilitate automatic and efficient sharing of content. In one embodiment, the content object 111 is protected against authorized distribution and/or access using one or more binding keys. More specifically, the binding keys associated the web server 103 and/or the web page 109 with the content object 111 so that the content object 111 will only display content based on requests originating from the bound web server 103 and/or the bound web page 109.

The content, for example, is provided by one or more of the services 113a-113n of the service platform 101. In one embodiment, the service platform 101 includes one or more services 113a-113n (e.g., music service, mapping service, video service, social network service, etc.), a content object binding manager 115a, a user account manager 115b, a binding data database 117a, and a user account database 117b. The services 113a-113n are connected directly or indirectly to network 107 and may be associated to share login credentials for granting user access. In another embodiment, one or more of the services 113a-113n are managed services provided by a service provider or operator of the network 107.

The content object binding manager 115a, for instance, manages the generation and distribution of unassociated binding keys for the automatic binding of hosts (e.g., web server 103, web page 109) with the respective content object 111. In addition, the content object binding manager 115a tracks the hosts that have been bound to the content object 111 to enable unbinding of the hosts from the content object 111 on a host-by-host basis. More specifically, the content binding manager stores binding information regarding hosts, the content object 111, and the binding relationships between them. By way of example, the content object binding manager 115a may store the binding information in the database 117a. In addition or alternatively, the binding data database 117a can reside on one or more nodes connected directly or indirectly to one or more of the services 113a-113n. In other embodiments, the binding data database 117a resides on one or more nodes in network 107 and can include one or more processes (not shown) and one or more data structures that store information about each content object 111 and the hosts that have been bound to the content object 111 as well as data, configurations, user profiles, variables, conditions, and the like associated with the binding processes.

The user account manager 115b, for instance, manages the sharing of login credentials by tracking which of the services 113a-113n share login credentials and then linking the credentials to the user accounts created with the various services 113a-113n a particular user. By way of example, the user account manager 115b may store the tracking information for the login credentials and the user account information in the user account database 117b. In addition or alternatively, the user account database 117b can reside on one or more nodes connected directly or indirectly to one or more of the services 113a-113n. In other embodiments, user account database 117b resides on one or more nodes in network 107. More specifically, the user account database 117b includes one or more processes (not shown) and one or more data structures that stores information about registered user each of the services 113a-113n including login credentials and related information as well as data, configurations, user profiles, variables, conditions, and the like associated with using any of the services 113a-113n.

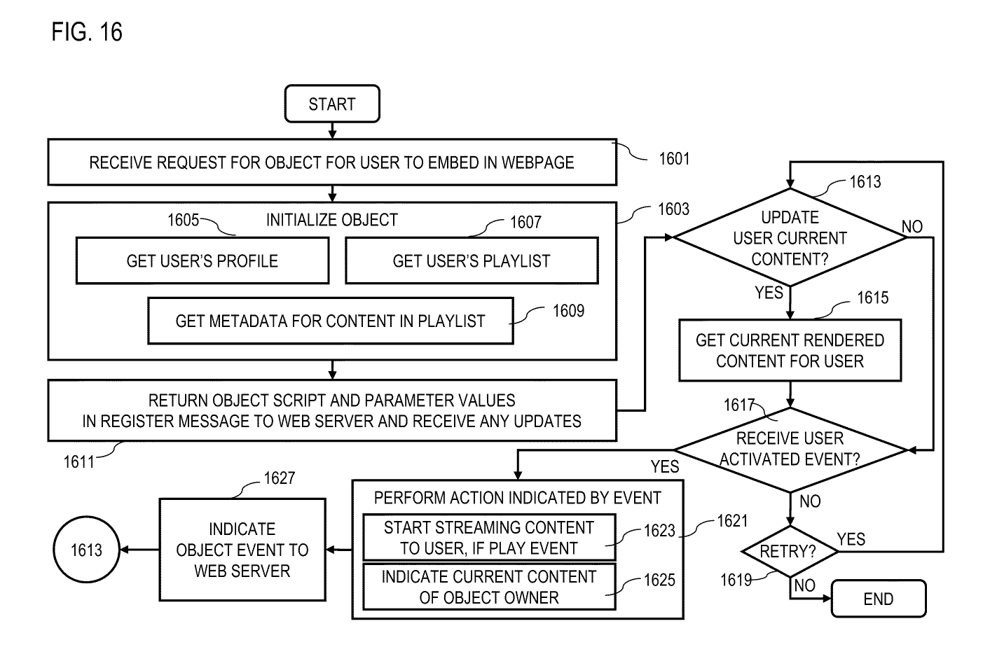

One or more of the services 113a-113n (e.g., the service 113a) can include a content object service 119 to enable content-sharing software objects, or content indicator software objects, called content objects 111 herein, to be delivered to a user's terminal for embedding into other web sites, as described in more detail below with reference to FIG. 16. Software objects that are self-contained collections of data and methods are widely known and used in object-oriented programming (OOP). Thus, as used herein, a content object 111 is a software object that can be embedded in a web page or email or other message for presentation to a user. In one embodiment, the content object service 119 includes an application programming interface (API) (not shown) to communicate and/or control the execution or embedding of the content object 111 in the web page 109. By way of example, the API defines routines, data structures, procedures, protocols, and the like that the content object 111 can use to exchange information with the corresponding service 113.

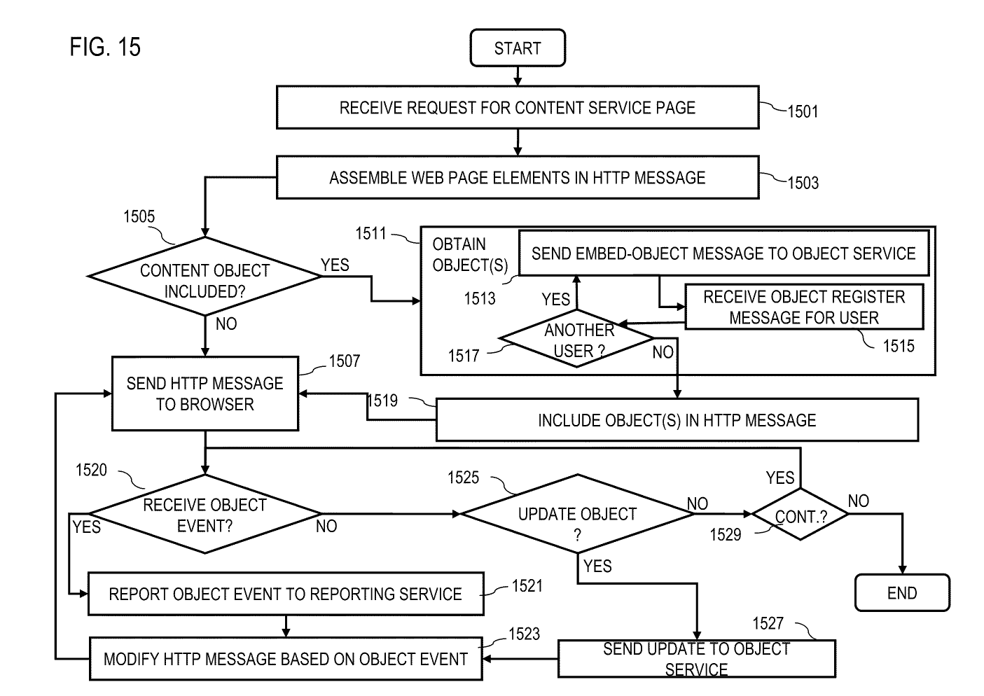

In some embodiments, the web server 103 interacts with the content object service 119 and the content object binding manager 115a to embed and authorize one or more content objects in one or more web pages (e.g., web page 109) delivered to a user's web browser (e.g., browser 121a on UE 105a or browser 121b on UE 105b), as described in more detail below with reference to FIG. 15. In addition or alternatively, the one or more web pages 109 may be delivered to the service application 123a of UE 105a or service application 123b of UE 105b. In one embodiment, the service applications 123 are local clients of the corresponding service 113 of the service platform 101. Thus web server 103 is depicted as including the web page 109 that includes the content object 111. In other embodiments, content objects 111 are embedded in messages sent by other application servers or clients, e.g., messages sent from email, instant messaging (IM), SMS messaging, MMS messaging, binary logs (BLOGs) and file transfer servers.

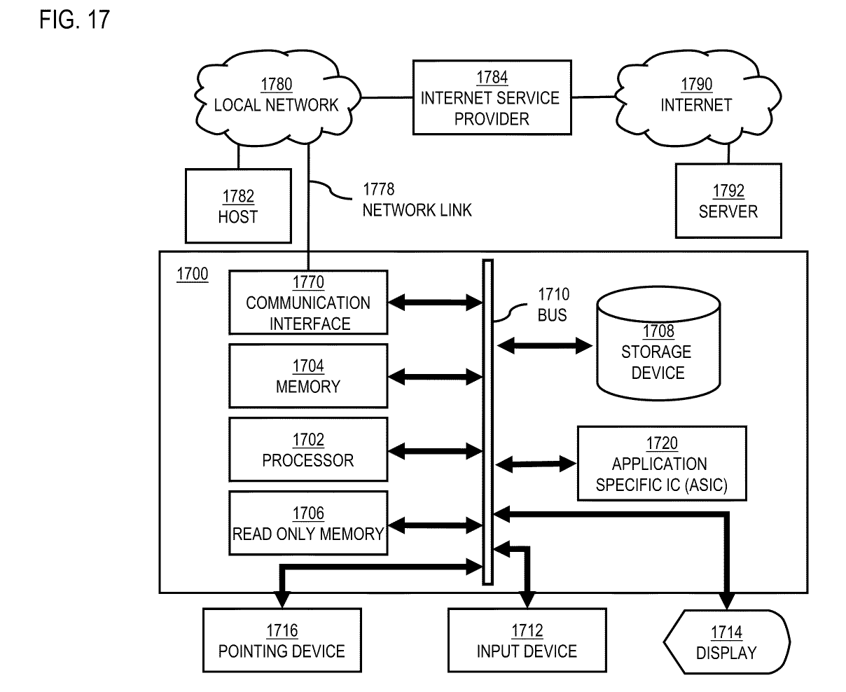

In one embodiment, the service platform 101 and the web server 103 can be implemented via shared, partially shared, or different computer hardware (e.g., the hardware described with respect to FIG. 17).

By way of example, the communication network 107 of the system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

The UEs 105 are any type of mobile terminal, fixed terminal, or portable terminal including a mobile handset, station, unit, device, multimedia tablet, multimedia computer, Internet node, communicator, desktop computer, laptop computer, Personal Digital Assistants (PDAs), or any combination thereof. It is also contemplated that the UE 105 can support any type of interface to the user (such as “wearable” circuitry, etc.). The UE 105 may also be equipped with one or more sensors (e.g., a global positioning satellite (GPS) sensor, accelerometer, light sensor, etc.) for use with the services 113a-113n.

By way of example, the UEs 105, the service platform 101, and the web server 103 communicate with each other and other components of the communication network 107 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the content object 111 and the corresponding service 113 interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

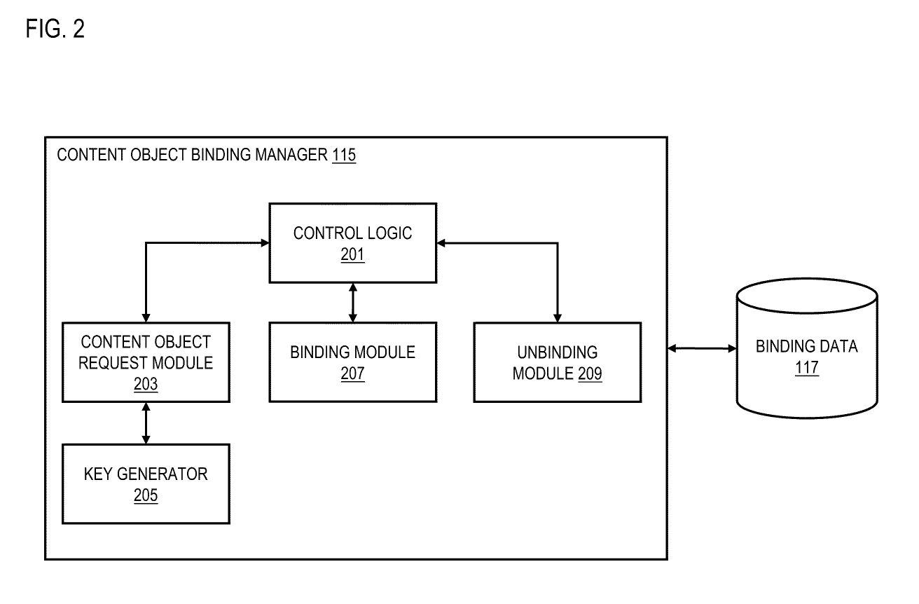

FIG. 2 is a diagram of the components of a content object binding manager, according to one embodiment. By way of example, the content object binding manager 115a includes one or more components for protecting an embedded content object via binding keys. It is contemplated that the functions of these components may be combined in one or more components or performed by other components of equivalent functionality. In this embodiment, the content object binding manager 115a includes at least a control logic 201 which executes at least one algorithm for executing functions of the content object binding manager 115a. For example, the control logic 201 interacts with the content object request module 203 receive and respond to requests for a content object 111. More specifically, the request is a request for the embedding code for the content object 111 that a user can embed into any displayable medium (e.g., web page, email, SMS message, MMS message, instant message, etc.). Once embedded, the embedding code for the content object 111 can, for instance, retrieve content or provide access to actions or features of a service 113 associated with the content object 111. In one embodiment, the request is received from the user via the browser 121 or service application 123 executing on the UE 105. By way of example, the request may specify the service 113 corresponding to the content object 111 of the requested embedding code, and identification of the owner (e.g., the user associated with the content object 111).

On receipt of the request for the embedding code for the content object 111, the content object request module 203 interacts with the key generator to retrieve an unassociated binding key to include in the content object 111 embedding code. In one embodiment, the key generator 205 generates one unassociated binding key for display or use at a time. That is, the key generator 205 need not generate a new binding key every time the user requests or is shown the embedding code. Instead, the key generator 205 generates a new unassociated binding key after the current unassociated binding key has been used to bind the content object 111 with a host. In other words, after the unassociated binding key has been bound, the key generator 205 generates a new unassociated binding key for any subsequent requests for the embedding code of the same content object 111. In addition or alternatively, it is contemplated that the key generator 205 may generate any number or combination of binding keys. The content object request module 203 then includes the generated unassociated binding key in the content object 111 embedding code for transmission to the requestor.

The control logic 201 then directs the binding module 207 to begin monitoring or detecting when a request for content from the content object 111 including an unassociated binding key from the respective embedding code is received. This request may be received or indicated by receipt of a request to load the embedded content object 111 at a browser 121 when the browser 121 is directed to, for instance, a web page or other displayable medium containing the embedding code associated with the content object 111. By way of example, the request includes at least the unassociated binding key and an identifier (e.g., a uniform resource locator (URL) address) associated with the host (e.g., web server 103, web page 109) in which the content object 111 embedding code was embedded. In response, the binding module 207 binds the content object 111 with the host identified in the request. In one embodiment, the binding module 207 stores information related to the bound hosts in the binding data database 117a. The binding process ensures that requests for information or content from the content object 111 to the corresponding service 113 will be served only if the request originates from the bound host. In one embodiment, it is contemplated that the binding module 207 uses a unique binding key for each host that is bound. In another embodiment, the binding module 207 may use the unique binding key to bind a predetermined number of hosts before a new unassociated binding key is generated. Using one binding key per host ensures a high level of protection against possible unauthorized extraction and copying of the content object 111 to another web page or other displayable medium. Whereas, providing for a predetermined number of hosts per binding key offers convenience to the user when the user plans to embed the content object 111 into multiple media. In yet another embodiment, it is contemplated that the binding module 207 may use any combination of a single or multiple number of uses per binding key before a new unassociated binding is generated.

As shown in FIG. 2, the content object binding manager 115a also includes an unbinding module 209 to facilitate tracking and management of hosts bound to the content object 111. For example, on request from the user, the unbinding module 209 can present a list of all hosts that have been bound to a particular content object 111. This list is compiled from, for instance, the binding information stored in the binding data database 117a. The unbinding module 209 also provides the option for the user to select specific hosts to unbind. The unbinding process removes, for instance, any binding information or association between the content object 111 and the unbound host. In this way, the host will no longer be able to receive content from the corresponding service 113 to present in the content object 111. This unbinding process advantageously enables to the user to disable a content object 111 without having to remove the embedding code of the content object 111 from the medium (e.g., web page 109) in which the embedding code for content object 111 was inserted.

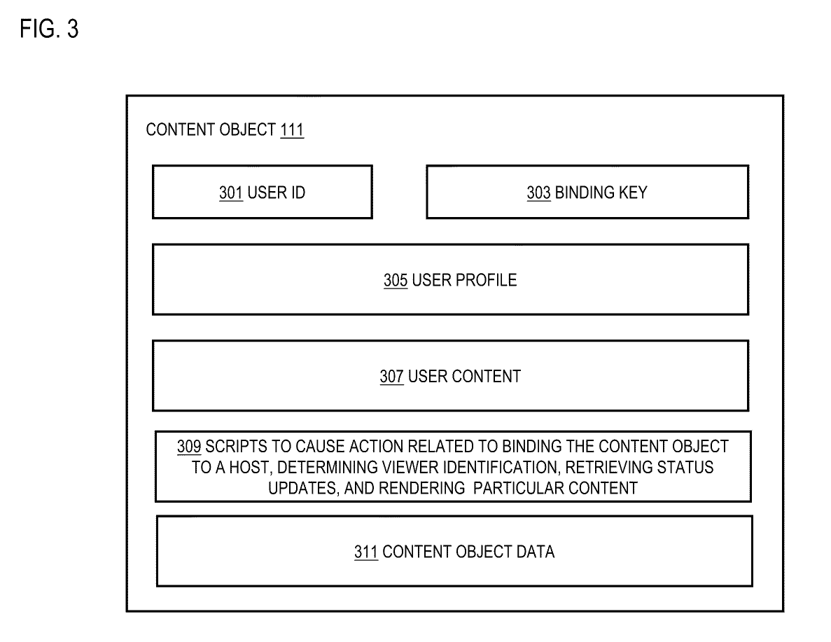

FIG. 3 a diagram of a content object, according to one embodiment. By way of example, the content object 111 includes one or more components for presenting content from a service 113, for customizing the presented content based on, for instance, identity information of the viewer and/or status information of the owner of the content object 111, and for binding the content object to a specific host. It is contemplated that the functions of these components may be combined in one or more components or performed by other components of equivalent functionality. In one embodiment, the content object 111 includes, for example: (1) a user ID field 301; (2) a binding key field 303; (3) a user profile field 305; (4) a user content field 307; (5) a script field 309 holding or pointing to scripts to be executed by a client process in order to cause actions related to binding the content object 111 to a host, determining identification information of the viewer, customizing the content based on the identification information, retrieving status updates from the owner of the content object 111, and/or rendering the particular content; (6) a data field 311 for the content presented by the content object 111; or (7) a combination thereof.

The user ID field 301 holds data that indicates, for example, a user registered with the service 113 associated with the content object 111. Any user ID may be used, such as a node identifier for the device used for rendering the content, a user supplied name, an email address, or an ID assigned to a user who registers with the service platform 101. In some embodiments, a user ID is inferred from a node identifier for the device used for rendering the content included in a lower protocol header. In some embodiments, the user ID field 301 is omitted. In some embodiments, a user is authenticated and authorized to access the service platform 101 in a separate login process, not shown, but well known in the art.

The binding key field 303 stores a binding key associated with the content object 111. The binding key may be in, for instance, one of two states (e.g., an unbound state and a bound state) depending whether the content object 111 has been bound to a specific host. When first generated (e.g., before embedding into a displayable medium), the binding key field 303 typically holds an unbound or unassociated binding key. In this state, the content object 111 has not yet been associated with a specific host. After embedding of the content object 111 into a displayable medium (e.g., web page 109), an initial access of the content object initiates the binding of the content object 111 and the host supporting the initial access. At this point, the state of the binding key in the binding key field 303 changes to a bound state. The change in the state of the binding key field 303 need not result in a change in the value of the binding key field 303. Instead, the state is applied at the content object binding manager 115a. More specifically, the content object binding manager 115a associates a particular state (e.g., bound or unbound) with the binding key value contained in the binding key field 303.

The user profile field 305 comprises data that indicates the user profile of the owner of the content object 111 (called owner hereinafter), such as one or more of any of the following: user account information for the owner with respect to the corresponding service 113; the owner's authorization or login credentials (such as password for accessing the user's home page) for accessing the service 113; a pointer to the owner's content in the service 113; one or more home pages for the owner on corresponding social networks, contact lists; and/or other external services 113; the owner's contact information such as email address, an image of the owner, a theme song of the owner, a visual theme of the owner, or an avatar of the owner. In one embodiment, the user profile field 305 may include a field (not shown) for indicating the owner's friends. This field, for instance, holds data that indicates one or more user IDs of other users associated with the owner in the one or more social networks and/or contact lists.

The user content field 307 holds data that indicates the content identifiers (content IDs) for one or more content items (e.g., music track, video, etc.) associated with the owner in the corresponding service 113 (e.g., music play history, such as values for song name and artist name in a music service). In one embodiment, the user content field 307 includes default content and customized content. Default content holds data that indicates the predetermined content to display with respect to the service 113 of the content object 111. For example, in a music service, the default content can specify the playlist that represents the owner's theme or taste in content, such as a theme song for the owner and/or the owner's top ten songs. Customized content holds data that is customized based on identification information associated with the viewer. In addition or alternatively, the customized content may indicate the content information representing the most recently rendered or currently rendered content of the owner (e.g., the song currently playing on owner's UE 105) or other real-time status information of the owner (e.g., active or inactive state, service accomplishments, etc.).

The script field 309 holds data for one or more scripts that indicates one or more processes and/or actions to be performed by the content object 111, such as a process to bind the content object 111 to a particular host. The script field 309 may indicate a process to present the content object 111 to a user and a process to respond to user input associated with the content object 111, such as activating an action presented by the content object 111 (e.g., playing the owner's theme song, playing the owner's current song, playing short segments (denoted as “snippets”) of all the content in the playlist, playing the owner's top ten list, buying currently/previously playing content, requesting more information about some content, and/or sending messages or otherwise contacting the owner of the locket). As is well known in the art, scripts are instructions that cause a web browser or other like application to perform one or more functions. For example, script in the JAVA™ programming language, called a JAVA applet, causes a web browser with a Java engine to perform the steps indicated in the script, as is well known in the art. In other embodiments, the script field 309 may include information or data to support implementation other methods including scripting or script-like functions such as Adobe Flash (ActionScript), AJAX, Web Runtime (WRT), and the like.

The content object data field 311 holds other data used by the content object 111, such as an image (icon) and/or avatar to represent the content object 111 on a display device, type or form of the content object 111 (e.g., a circle, bubble, star form, rectangle, cube, polyhedron) and/or other related information (e.g., degree of similarity between the viewer and the owner; the percentage of the locket owner's playlist or play history, or both, that falls into each of multiple categories; etc.).

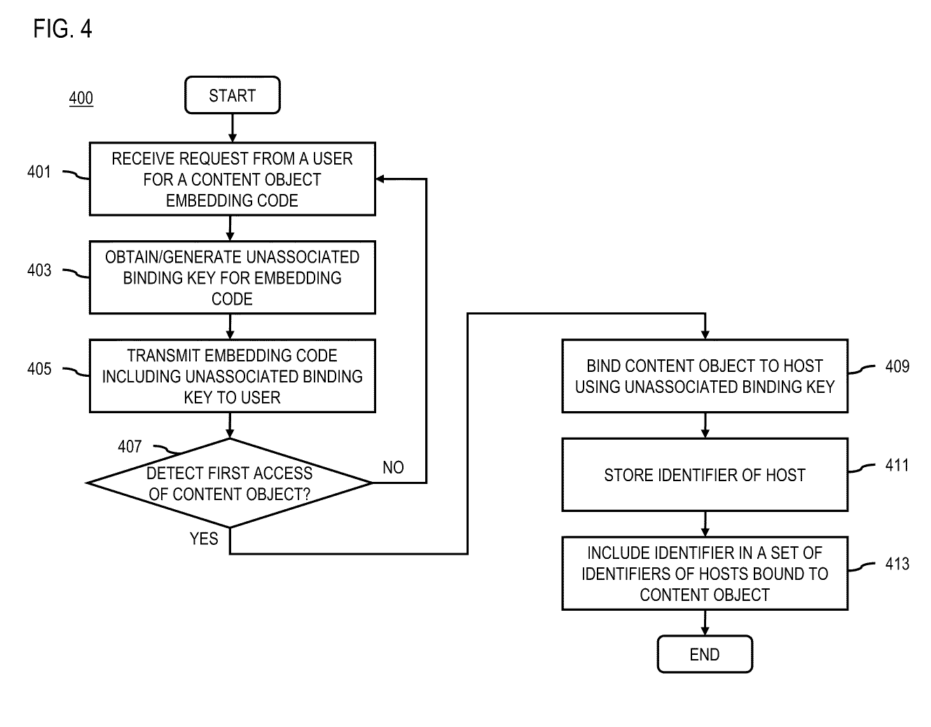

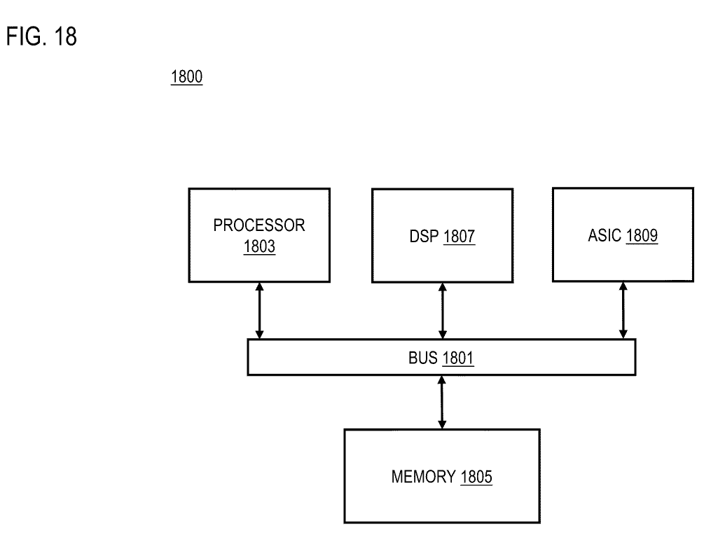

FIG. 4 is a flowchart of a process for binding a content object to a host using an unassociated binding key, according to one embodiment. In one embodiment, the content object binding manager 115a performs the process 400 and is implemented in, for instance, a chip set including a process and a memory as shown in FIG. 18. In step 401, the content object binding manager 115a receives a request from a user for embedding code corresponding to a content object 111. This embedding code can used by the owner of the content object 111 to embed the content object 111 in a displayable medium (e.g., web page 109, email, text messaging, multimedia messaging, instant messaging, etc.). As previously described, the owner may insert the embedding code associated with the content object 111 into a displayable medium by copying the embedding code and pasting the code into the code associated with the displayable medium.

In response to the request, the content object binding manager 115a obtains or generates an unassociated binding key to include in the requested embedding code for the content object 111 (step 403). For example, if a previously generated unassociated binding key is available and has not yet been bound to a host, the content object binding manager 115a may retrieve the previously generated binding key to include in the content object 111 embedding code. If, however, no unassociated binding key is available or the previously unassociated binding key has been bound to a host, the content object binding manager 115a generates a new unassociated binding key to include in the content object 111 embedding code. Next, the binding manager 115a causes, at least in part, actions that result in transmission of the content object 111 embedding code including the unassociated binding key to the UE 105 associated with the user (step 405). In one embodiment, the content object 111 embedding code is transmitted by providing a field in a web page including the embedding code. The owner may then copy the embedding code from the field to embed in a displayable medium. In addition or alternatively, the binding manager 115a may initiate the transmission of the embedding code (e.g., as a file) to the UE 105 of the owner over the communication network 107.

After the owner of the content object 111 embeds the corresponding embedding code into a displayable medium, the content object binding manager waits to detect a request for first access to the content object (step 407). By way of example, the first access may be requested by the owner as a test or preview of the medium (e.g., web page 109) in which the content object 111 was embedded. During the test or preview, the owner's browser 121 makes a request to the corresponding service 113 for the content object 111 based on the embedding code. The request includes, for instance, the unassociated binding key and an identifier (e.g., URL) associated with the host making the request. In one embodiment, the host identifier is provided in the referrer header transmitted by the browser 121 as part of the request. The referrer header includes the URL of the web page 109 or host holding the embedded content object 111.

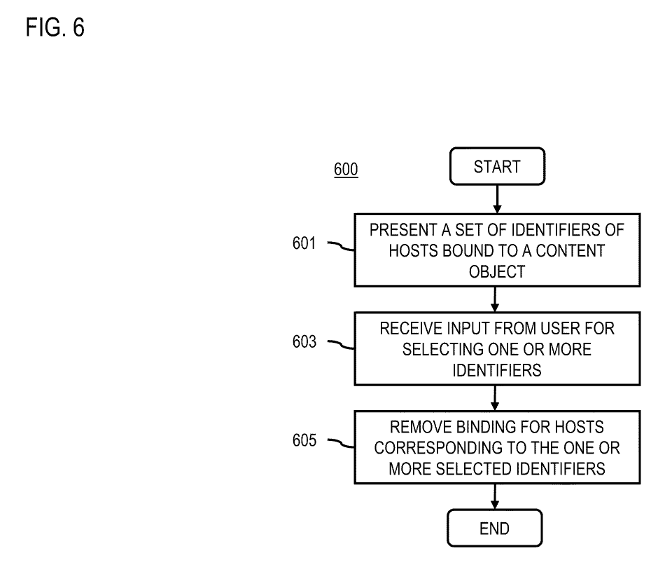

After receiving the request including at least the unassociated binding key and the identifier of the host, the content object binding manager 115a binds the content object 111 to the host using the unassociated binding key (step 409). In one embodiment, the unassociated binding key can then no longer be used to bind any other hosts. Accordingly, the binding manager 115a would have to generate a new unassociated binding key for subsequent requests for the content object 111. After binding, requests for content related to the content object 111 that are identified with the binding key are allowed if they come from the same host as identified during the binding process. The content object binding manager 115a then stores the identifier of the host (step 411) and includes the identifier of the host in a set of identifiers associated with other hosts (if any) that have been bound to the same content object 111 (413). In this way, the content object binding manager 115a supports tracking and removal of bound hosts as described below with respect to FIG. 6.

It is noted that in the embodiment described above, binding is performed according to when any first access request for the content object 111 is detected by the binding manager 115a regardless of who is making the request for first access. Typically, the first access is made as a test access by the owner of the content object 111 after embedding the code. However, it is recognized that there is window of opportunity (e.g., after embedding the code and before binding the code on first access) where another user may copy the embedding code with the unbound key from an external web site and place the code on some other site. Then requesting the content object 111 from the other site would result in binding the key with that other site.

Accordingly, in certain embodiments, the binding manager 115a can associate a unique identifier (e.g., an Internet Protocol (IP) address, a network address, and the like) corresponding specifically to the owner of the content object 111 or the owner's device to ensure that binding is performed by the owner and not another user. By of example, the unique identifier may be included in the content object 111 embedding code with the unassociated binding key. In this way, the unique identifier can be transmitted during first access of the content object 111 along with the unassociated binding key during the binding process described previously.

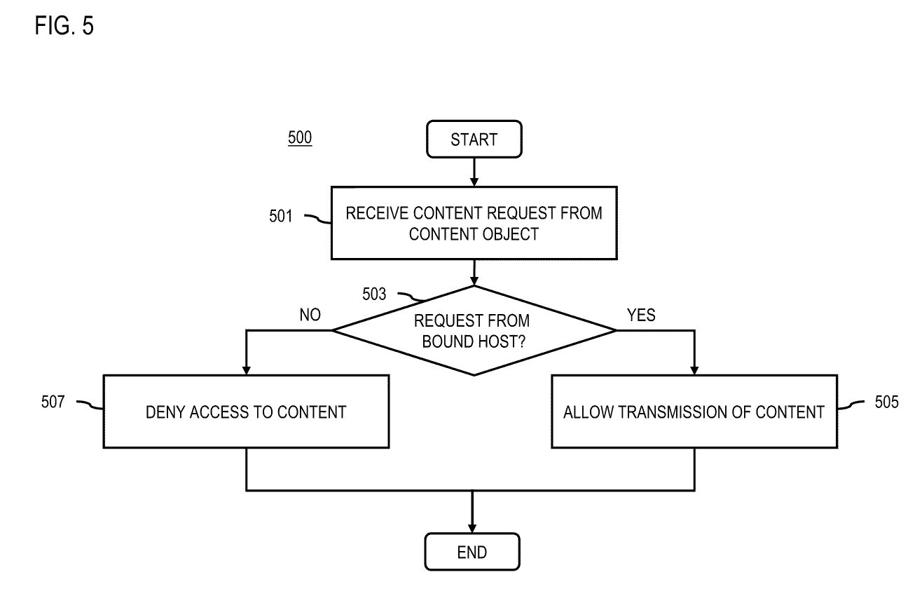

FIG. 5 is a flowchart of a process for protecting access to data of a content object using a binding key, according to one embodiment. In one embodiment, the content object binding manager 115a performs the process 500 and is implemented in, for instance, a chip set including a process and a memory as shown in FIG. 18. The process 400 assumes that the content object 111 has already been embedded to a web page 109 or other displayable medium. In step 501, the content object binding manager 115 a receives a content request from an embedded content object 111. For example, the request may come directly from the content object 111 or the request may be relayed from the web server 103 and/or the content object service 119 of the service 113. The request includes at least the binding key associated with the content object 111 and an identifier of the host (e.g., transmitted in the referrer header).

Next, the binding manager 115a determines whether the request originates from a host (e.g., web page 109) that has been bound to the content object 111 with the received binding key (step 503). To make this determination, the binding manager 115a compares, for instance, the received binding key and host identifier against the stored list of binding keys and host identifiers. If the received host identifier matches the host identifier recorded for the received binding key, the content object binding manager 115a determines the request originates from a bound house and allows transmission of the requested content or data from the service 113 (step 505). If, however, there is no match, the binding manager 115a denies access to content by the requesting content object 111 and/or host (step 507).

FIG. 6 is a flowchart of a process for removing the binding between a host and a content object, according to one embodiment. In one embodiment, the content object binding manager 115a performs the process 600 and is implemented in, for instance, a chip set including a process and a memory as shown in FIG. 18. The process 600 assumes that the content object 111 has been successfully bound to one or more hosts. In step 601, the content object binding manager 115a presents a set of identifiers (e.g., URLs) associated with hosts (e.g., web page 109) that have been bound to the content object 111 using, for instance, the process 400 as described above. The presentation of the set of identifiers may be initiated by a user on selection of, for instance, an option to remove the binding for bound hosts. The described process may also be used by the user to review all bound hosts without having to remove the binding of any of the hosts. In this way, the user can confirm or review all of the hosts currently authorized to display content via the content object 111.

If the user intends to remove the binding of one or more of the presented hosts, the user may select corresponding one or more identifiers from the list. The content object binding manager 115a receives the input from the user making the selection (step 603) and removes the binding between the one or more selected hosts and the content object 111 (step 605). By way of example, the binding manager 115a may remove the binding of a host from the content object 111 by eliminating the association or relationship between the host and the content object 111 from the binding data database 117a. It is noted that because each binding key is used only once, the binding key in the embedding code of the unbound content object 111 is note reused. Accordingly, subsequent access to the unbound content object 111 and/or related content would be denied. The approach described herein for removing the binding of a host advantageously enables the user to manage binding relationships remotely. For instance, instead of having to manually remove the embedding code from each web page 109 or displayable medium, the user need only remove the binding to prevent data from being displayed at the content object 111. By way of example, an unbound content object 111 may display no content, graphics, user interface elements, etc. to effectively make the unbound content object 111 invisible within the unbound host. Alternatively, the unbound content object 111 may be configured to display an error message, to redirect the viewer to a general web page 109 of the corresponding service 113, to display generic content, etc. In any case, access to content by either the unbound content object 111 or the unbound host is not permitted. To rebind the content object 111 with an unbound host, the content object 111 owner, for instance, would request an embedding code with a new unassociated binding key to embed at the host.

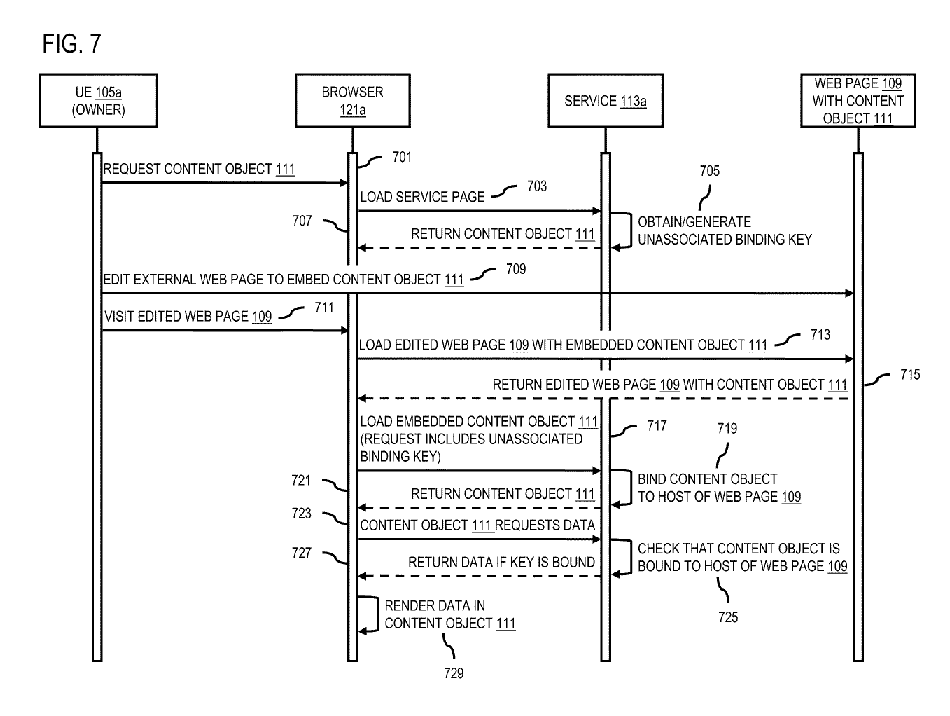

FIG. 7 is a time sequence diagram that illustrates a sequence of messages and processes for binding a content object to a host using an unassociated binding key, according to one embodiment. A network process on the network is represented by a thin vertical box. A message passed from one process to another is represented by horizontal arrows. A step performed by a process is indicated by a box or looping arrow overlapping the process at a time sequence indicated by the vertical position of the box or looping arrow.

The processes represented in FIG. 7 are the UE 105a corresponding to the owner of the content object 111, the browser 121a executed on the UE 105a of the owner, the service 113a of the content object 111, and the web page 109 with embedded content object 111.

To begin the process, the owner via the UE 105a initiates a request 701 to the browser 121a for the embedding code of a desired content object 111. The request 701, for example, directs the browser 121a to access a page of the service 113a from which the content object 111 can be requested (at 703). In one embodiment, the content object request page may display a menu option or button to request the embedding code for the content object 111. In the process 705, the service 113a via the content object binding manager 115a obtains or generates an unassociated binding key as described with respect to the process 400 of FIG. 4. This service 113a returns the embedding code for the content object 111 including the unassociated binding key to the browser 121a (at 707).

As discussed earlier, the service 113a may return the embedding code in a field that can be cut and then pasted into any displayable medium (e.g., web page 109) by the user. After obtaining the embedding code, the owner edits an external web page 109 to embed the received content object 111 along with the unassociated binding key (at 709). For example, the owner may retrieve a music service content object 111 for displaying the owner's musical preferences and then embed the music service content object 111 in the user's social networking personal profile page. Next, the user visits the edited web page 109 by directing the browser 121a to the corresponding page (at 711).

In response, the browser 121a sends a request 713 to load the edited web page 109 containing the embedded content object 111. The request 713 results in the web page 109 returning web code (e.g., HTML code) to the browser 121a for displaying the web page 109 with the embedded content object 111 (at 715). The browser 121a then initiates rendering of the content object 111, which initiates a request 717 to perform a first load (e.g., first access) of the embedded content object 111. In one embodiment, the request 717 includes the unassociated binding key and an identifier (e.g., URL) of the web page 109 containing the content object 111.

The binding manager 115a of the service 113a then performs the binding process described with respect to FIG. 4 to bind the content object 111 to the identified host using the unassociated binding key (at 719). The binding manager 115a returns the bound content object 111 to the browser 121a in a message 721. On initiation of the display of the bound content object 111, the content object 111 requests data from the service 113a to present in the content object 111 (at 723). The service 113a receives the request and determines whether the request originates from a bound host by checking that the host identifier associated with the request matches the host identifier recorded for the corresponding binding key (at 725). After verification of the binding status, the service 113a transmits a message 727 returning the requested data to the content object 111. The content object 111 then renders or displays the received data or content in the content object 111.

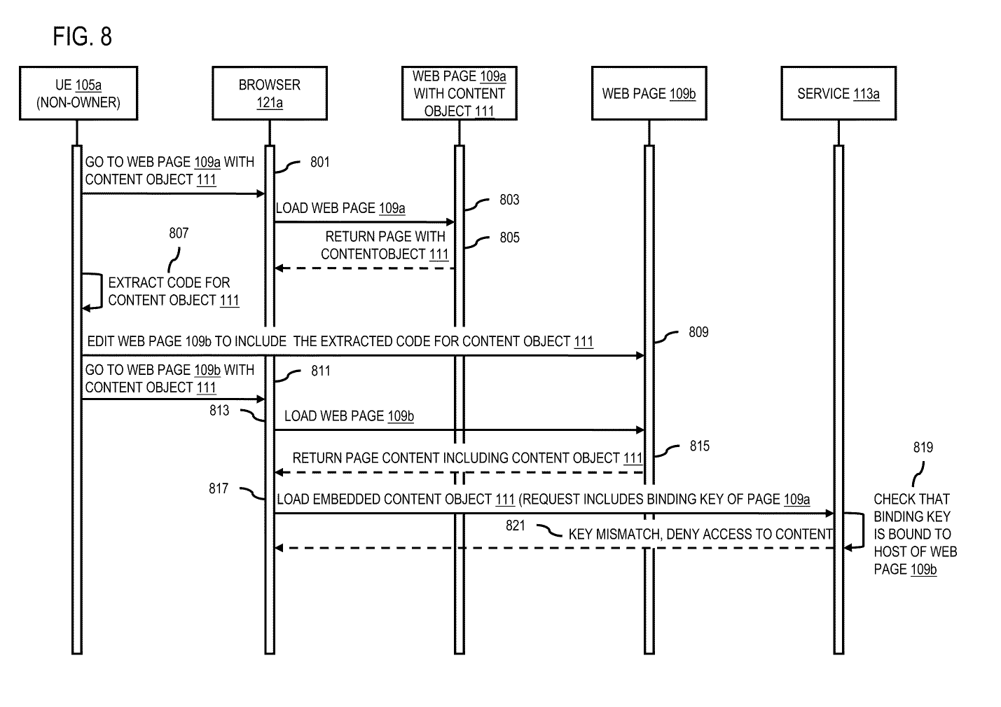

FIG. 8 is a time sequence diagram that illustrates a sequence of messages and processes for protecting access to data of a content object using a binding key; according to one embodiment. A network process on the network is represented by a thin vertical box. A message passed from one process to another is represented by horizontal arrows. A step performed by a process is indicated by a box or looping arrow overlapping the process at a time sequence indicated by the vertical position of the box or looping arrow.

The processes represented in FIG. 8 are the UE 105a corresponding to the non-owner of the content object 111, the browser 121a executed on the UE 105a of the non-owner, the web page 109a bound to a content object 111, a web page 109b not bound to the content object 111, and the service 113a of the content object 111.

In step 801, a non-owner of the content object 111 initiates a request to view the web page 109a that is bound to the content object 111. In this case, the non-owner is any user other than the owner of the content object 111. The request directs the browser 121a to the web page 109a for loading and display in the browser 121a (at 803). The web page 109a returns a message 805 including the web code (e.g., HTML code) for displaying the web page 109a including the embedding code for the content object 111. On receipt of the code, the non-owner extracts the embedding code for the content object 111 (at 807). By way of example, to extract the embedding code, the non-owner views the source code of the web page 109a and copies the embedded code.

Using the extracted embedding code, the non-owner via the UE 105a edits a second web page 109b to include the extracted code for the content object 111 (at 809). The non-owner then accesses the edited web page 109b to view the page (at 811). To access the page, the browser 121a is directed to load the web page 109b (at 813), which returns the requested web code of the web page 109b (at 815). Because the web page 109b includes the embedding code for the content object 111, the display of the edited web page 109b causes a request 817 that is directed to the service 113a to load the content object at the web page 109b. This request includes the binding key of the content object 111 as well as the referrer header of the request identifying the host (e.g., web page 109b).

The content object binding manager 115a of the service 113a receives the request and checks to determine whether the requesting host, i.e., the web page 109b, is bound to the content object 111 and, therefore, authorized to receive the content. The binding manager 115a compares the received host identifier against the host identifier recorded for the corresponding binding key (at 819). However, in this case, the received host identifier does not match the recorded host identifier for the specified binding key because the binding key was originally used to the bind the content object 111 with the web page 109a rather than the web page 109b to which the embedding code was copied. According, the service 113a denies access to the requested data by, for instance, not returning any data in response to the request (at 821). In addition or alternatively, the service 113a may also return an error message or warning that the binding key does not match the requesting host. In either case, the binding manager 115a denies access as described with respect to the process 500 of FIG. 5.

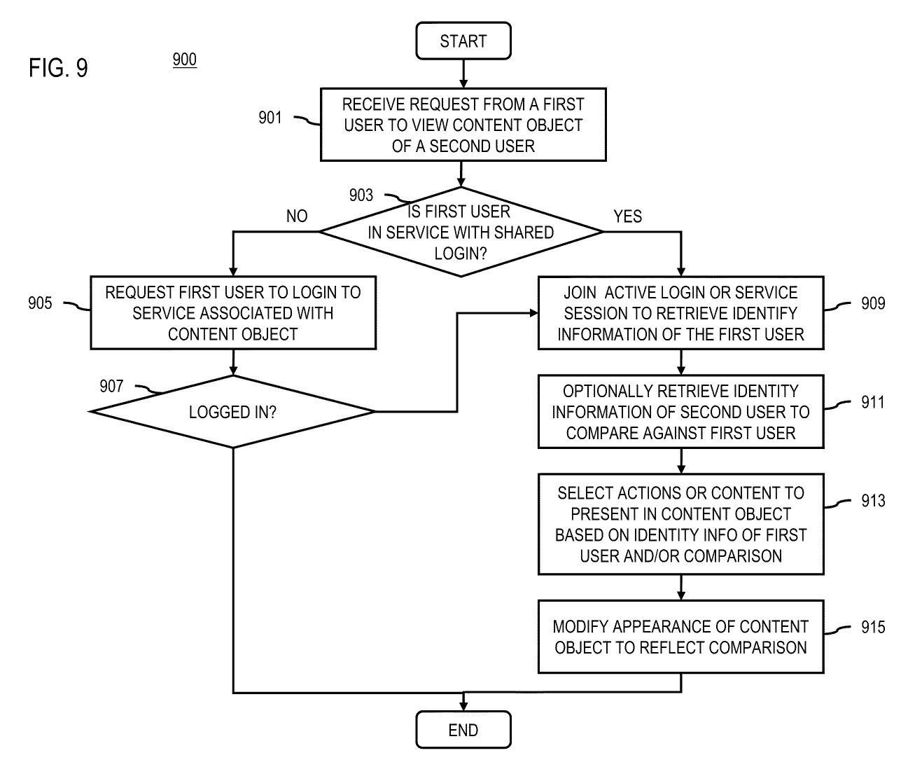

FIG. 9 is a flowchart of a process for customizing a content object based on a viewer of the content object, according to one embodiment. In one embodiment, the content object 111 performs the process 900 and is implemented in, for instance, a chip set including a processor and a memory as shown in FIG. 18. In step 901, the content object 111 receives a request from a viewer to view or access a content object 111 of the owner that is associated with a service 113 (e.g., a music service). By way of example, the request is signaled for instance when the viewer uses the browser 121a of the UE 105a to access a web page in which the content object 111 is embedded. The request may also be signaled if the viewer receives an email from the owner containing the content object 111. In certain embodiments, it is contemplated that the request can be initiated using any mechanism to cause viewing or execution of the content object 111 or the software contained therein.

On receiving the request, the content object 111 causes actions (e.g., execution of scripts) to determine whether the viewer is logged into (e.g., via the UE 105a) a service that shares login credentials or a login session with the service associated with the content object 111 (step 903). As described earlier, services employing shared login credentials are becoming increasingly popular way because the shared login credentials can reduce the burden on users for remembering and keeping track on multiple logins for multiple services. For example, service providers may offer suites of applications or services (e.g., email applications, mapping services, social networking services, music services) and have consolidated the login credentials and/or the login process for these suites of applications. In this way, a user of one of these services may login once to create an active login or service session. Because the login session or service session is based on shared login credentials, the other services sharing the credentials may join in on the active session with respect to the user without requiring the user to login in separately to the other services. In one example scenario, a service provider offers a mapping and a music service that share login credentials for users. A user who first logs into the mapping service may subsequently access the related music service without have to reenter or provide the user's login credentials again.

Therefore, based the determination by the content object 111 of whether the viewer is logged into a service that shares login credentials with the service associated with the content object 111, the content object 111 can initiate a process to obtain identification information about the viewer. For example, if the user is not logged into such a service, the content object 111 can initiate a script to request the login credentials directly from the viewer (step 905). The login information from the viewer can then be used to log the viewer into the service 113 associated with the content object 111 or other any other service 113 that shares login credentials. Once the user is logged in (step 907) or if the content object 111 has determined that the user was already logged in to a service sharing login credentials, the content object 111 can join or cause a browser 121 to join the viewer's active login or service session to retrieve identity information of the viewer (step 909). For example, the active login session can be used to automatically log the viewer into the service associated with the content object 111. Logging into the service of the content object 111, for instance, enables the content object 111 to access user account information associated with the viewer. More specifically, the user account information includes identity information of the viewer as stored for use by the service 113 associated with the content object 111.

In certain embodiments, the content object 111 can also retrieve identity information for the owner of the content object 111 (step 911). Accordingly, the content object 111 can initiate scripts or other actions to retrieve the identity information for the viewer and/or the owner. If information for both the viewer and the owner is available, the content object 111 can initiate a comparison of the similarities between the two sets of identity information. By way of example, the comparison may be conducted on data retrieved from the user profiles, content histories, service histories, etc. of the viewer and the owner. The comparison generates, for instance, a measure of the degree of similarities and differences between the viewer and the owner. In certain embodiments, the comparison may be specific to particular services. For example, if the service of the content object 111 is a music service, the comparison may include determining similarity in the genre information associated with the musical tracks in the accounts of the viewer and the owner respectively.

The content object 111 can then use the comparison in conjunction with the identity information of the viewer to select content, features, and/or actions to present to the viewer (step 913). For example, if the service in which the viewer is currently engaged is determined to share a common login session, a music service content object 111 may present only those genres of music that are reflected with the identity or user profile information of the user. The approach described herein does not limit the types of content (e.g., video files, documents, multimedia files, applications, etc.) that may be presented based on the comparison. The comparison may also be reflected in the representation of the content object 111 in the web page or other medium. In one embodiment, the content object 111 may modify the appearance or other representation of the content object 111 based on the comparison (step 915). For example, the content object 111 may be rendered in a color that reflects the determined degree of similarity. The content object 111, for instance, may display a red color when the degree of similarity is low or a green color when the degree of similarity is high. In other embodiments, similarity may be represented by symbols (e.g., plus or minus symbols, audio cues such as a buzz if similarity is low, etc.) displayed on or about the content object 111. It is contemplated that any means (e.g., graphics, audio, video, multimedia, etc.) can be used to indicate similarity.

Alternatively, the content object 111 may use the identity information of the viewer without the comparison to make the selection. In this case, the content object 111 can present content, features, and/or actions that are dependent on the viewer's identity. The specific content, features, and/or actions are tied to the specific type of service 113 that is matched to the content object 111. For instance, a music service content object 111 may enable instant one-click purchases of music content presented in the content object 111 because viewer is automatically logged into the music service of the content object 111. Other functions include enabling the viewer to rate or comment on the presented musical content, automatically download available tracks from the music service, update musical profile, upload content or information to a social networking service, etc. It is contemplated that any function dependent on the user being logged into a service 113 may automatically be presented in the content object 111.

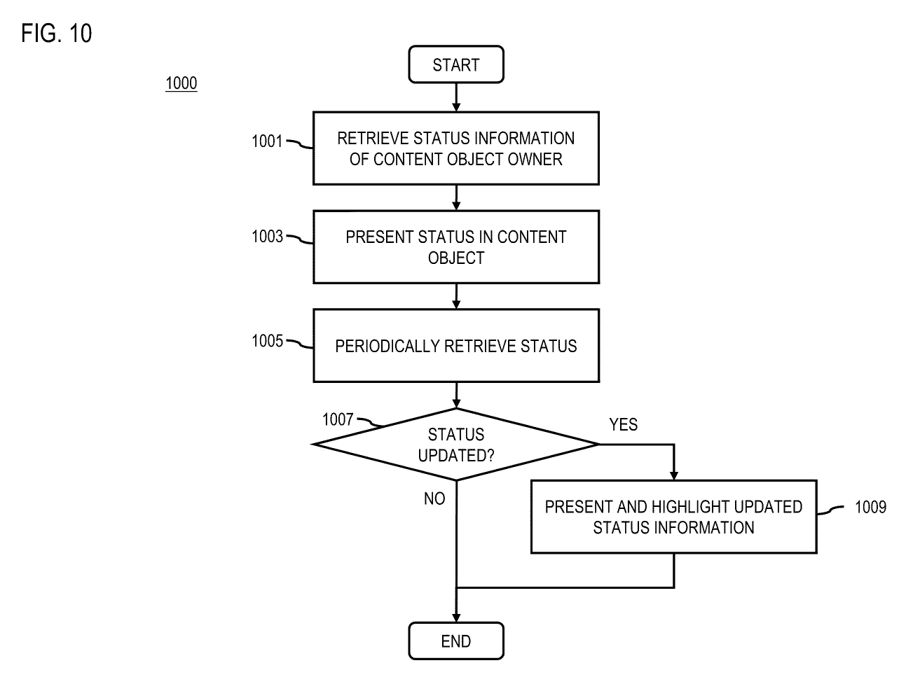

FIG. 10 is a flowchart of a process for customizing a content object based on the status of an owner of the content object, according to one embodiment. In one embodiment, the content object 111 performs the process 1000 and is implemented in, for instance, a chip set including a processor and a memory as shown in FIG. 18. The process 1000 assumes that a viewer has successfully retrieved a web page or other media in which the content object 111 has been embedded. In addition, the viewer may have optionally completed the process 900 of FIG. 9 to customize the content object 111 based on the viewer's identity information. In step 1001, the content object 111 retrieves status information of the owner based on the owner's use or activity with respect to the service 113 associated with the content object 111. For example, with respect to a music service, the status information may describe whether the owner is logged in, what music the owner is currently listening to, comments from the owner about the currently playing music, and the like. In other words, the status information described herein can provide information on a real-time or current state of the owner. The status information may also describe a current level of achievement, ranking, accomplishment, etc. of the owner with respect to the corresponding service 113. For example, in a gaming service, the status information may provide the game level or ranking currently achieved by the owner based on the owner's completion of specific games or levels within the games of the gaming service 113.

The content object 111 then presents the retrieved status information to the viewer (step 1003). It is contemplated that the content object 111 may use any form or representation (e.g., graphics, audio, multimedia, text, icons, badges, animation, pictures, etc.) to present the status information. For example, in one embodiment, the content object 111 presents status information as a circular halo surrounding the display of the content object 111 in a web page. The halo may then be made to glow or change colors based on the status information. In a music service, the color of the status ring or halo may be made to change in relation to the genre of music the owner is currently playing (e.g., red for rock music, blue for classical music, yellow for country music, etc.). Music spanning multiple genres may also use combinations or mixtures of the color to represent the multiple genres. In other embodiments, the content object 111 may render or cause the rendering of the status information as a long strip or other shape. The content object 111 may also change the theme (e.g., a defined set of graphical elements, sounds, design, etc.) for presentation of the content object 111 based on the status information. In another embodiment, the status information may be displayed as a textual label overlaid on the content object 111. For example, the owner of a social music service content object 111 is listening to music, a label showing “Now Listening” can be displayed over the representation of the content object 111.

In one embodiment, the content object 111 initiates a script to retrieve the status information using, for instance, an API of the content object service 119 within the corresponding service 113 (as described above). Moreover, the content object 111 may retrieve the status information periodically at predetermined intervals, continuously, on-demand, manually as initiated by the viewer or a combination thereof (step 1005). In one embodiment, the content object 111 may initiate a script to determine when status of the owner has been updated (step 1007). In addition or alternatively, the content object service 119 may initiate transmission of a signal message to the content object 111 when the owner's status has been updated. In either case, the content object 111 may retrieve the status update when an update is determined or signaled. In this way, network bandwidth usage for status updates can be reduced particularly when the owner's status does not change frequently.

On receiving an update, the content object 111 can initiate rendering or presentation of the received update in such a way that highlights to the viewer that an update has occurred (step 1009). For example, the content object 111 may cause a media player to play a chime to indicate receipt of a content update. The content object 111 may also change the rendering of its representation by flashing or changing colors. It is contemplated that the content may use any mechanism to draw the viewer's attention or provide notice to the viewer that the owner's status has changed. For example, a textual label of the updated status information may also be used.

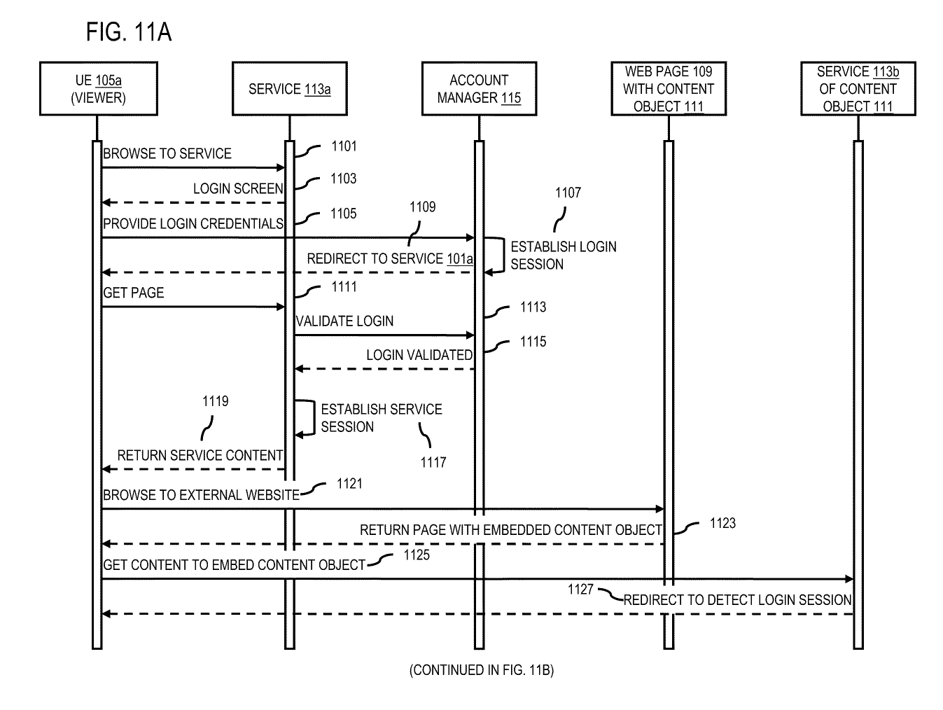

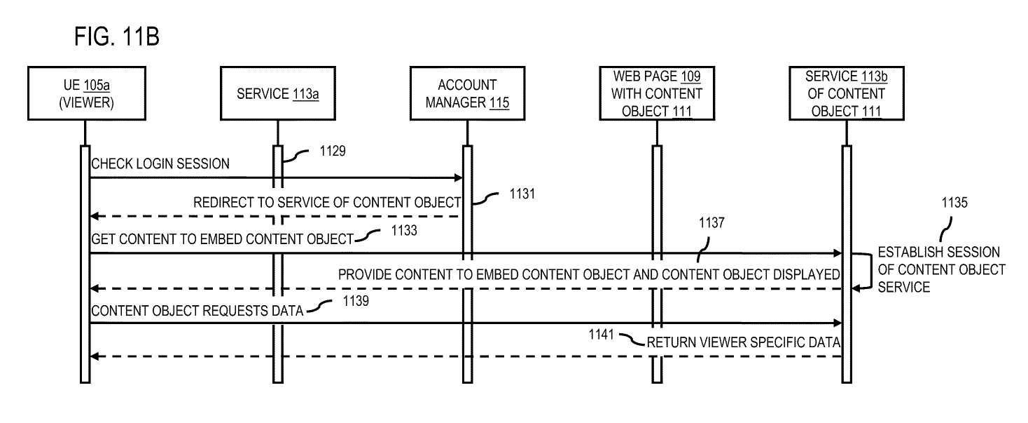

FIGS. 11A-11B are time sequence diagrams that illustrate a sequence of messages and processes for customizing a content object based on a viewer of the content object, according to various embodiments. The time sequence diagram of FIG. 11A continues to the diagram of FIG. 11B. Time increases downward in this and following time sequence diagrams. A network process on the network is represented by a thin vertical box. A message passed from one process to another is represented by horizontal arrows. A step performed by a process is indicated by a box or looping arrow overlapping the process at a time sequence indicated by the vertical position of the box or looping arrow.

The processes represented in FIGS. 11A-11B are the UE 105a corresponding to the viewer, the service 113a, the account manager 115b, the web page 109 with embedded content object 111, and the service 113b of the content object 111. For example, the service 113a (e.g., a mapping service) and service 113b (e.g., a music service) share common login credentials that are managed by the account manager 115b.

In the process 1101, the viewer via the UE 105a sends a request to browse the service 113a using, for instance, the browser 121a. For example, the request can be initiated by entering a web address corresponding to the service 113a into the browser 121a. In response, the service 113a returns a login screen web page 1103 directing the viewer to provide login credentials to access the service 113a. The viewer provides the login credentials via the UE 105a in a message 1105 to the account manager 115b. In one embodiment, the viewer may provide the login credentials by manual entry into the UE 105a or may initiate transmission of login credentials that have been previously stored in the UE 105a. In addition, the login credentials may include any authentication information (e.g., user name/password, biometric information, device address, etc.) to facilitate authentication of the viewer's UE 105a to access the service 113a.

The account manager 115b verifies the login credentials and establishes a login session based on the verification (at 1107). In one embodiment, the login session can be shared among all services 113 that share common login credentials. After establishing the login session, the account manager 115b transmits a message 1109 to the UE 105a redirecting the browser 121a of the UE 105a to the web page associated with the service 113a.

The UE 105a then issues a request 1111 to access the service 113a, which then validates the service request 1111 with the account manager 115b to confirm that the login session established for the UE 105a is valid (at 1113). On confirmation 1115 from the account manager 115b, that the login session is valid, the service 113a establishes an active session with the service 113a for the UE 105a (at 1117). At this point, the UE 105a has successfully completed the login process for the service 113a and begins receiving service content 1119 from the service 113a.

After beginning to use the service 113a, the viewer via the UE 105a sends a request 1121 to browse an external website. This website includes, for instance, a web page 109 containing the content object 111. This content object is, in turn, associated with another service 113b (e.g., a music service) that shares login credentials with the service 113a. In response to the viewer's request, the web page 109 returns a web page (e.g., HTML code) containing, for instance, a script to retrieve the content object 111 (at 1123). The UE 105a receives the web page 109 and initiates a request 1125 to the service 113b for the content object 111 to embed into the web page. The service 113b returns a message 1127 that includes a script to redirect the UE 105a to detect whether the UE 105a is already engaged in a login session that is shared by the service 113b.

Continuing in FIG. 11B, the UE 105a receives the redirection script and transmits a request 1129 to the account manager 115b to check for an active login session. In the process 1131, the account manager 115b determines whether the login session in which the UE 105a can be shared with the service 113b. The account manager 115b performs this check, for instance, by consulting a database (e.g., user account database 117b) for information to indicate that the service 113b shares login credentials with the service 113a. In one embodiment, this information is predetermined by the service provider. In this example, the account manager 115b determines that the service 113b does share the login session and redirects the UE 105 to the service 113b to obtain the content.

Accordingly, the UE 105a transmits another request 1133 for the content object 111 including confirmation that a login session is available to the service 113b. On receiving the request and confirmation, the service establishes a service session with the service 113 corresponding to the content object 111 for the viewer (e.g., logs the viewer in the service 113 of the content object 111) (at 1135). The service 113b then returns the content object 111 for the UE 105a to display (at 1137). On displaying of the content object 111 at the UE 105, the content object 111 transmits a request 1139 for data to present. On receiving the request, the service 113b joins the login session of the viewer to establish a service session for the viewer with the service 113b. By establishing the session, the service 113b can retrieve identification information about the viewer and customize the content to be presented in the content object 111 based on the identification information. For example, if the service 113b is a music service, the customized content may include options to purchase the presented music, download the presented music, download presented playlists, retrieve information about presented music, etc. This viewer specific content is then provided to the UE 105a in the process 1141, thereby customizing the content presented by the content object 111 based on the identification information of the viewer.

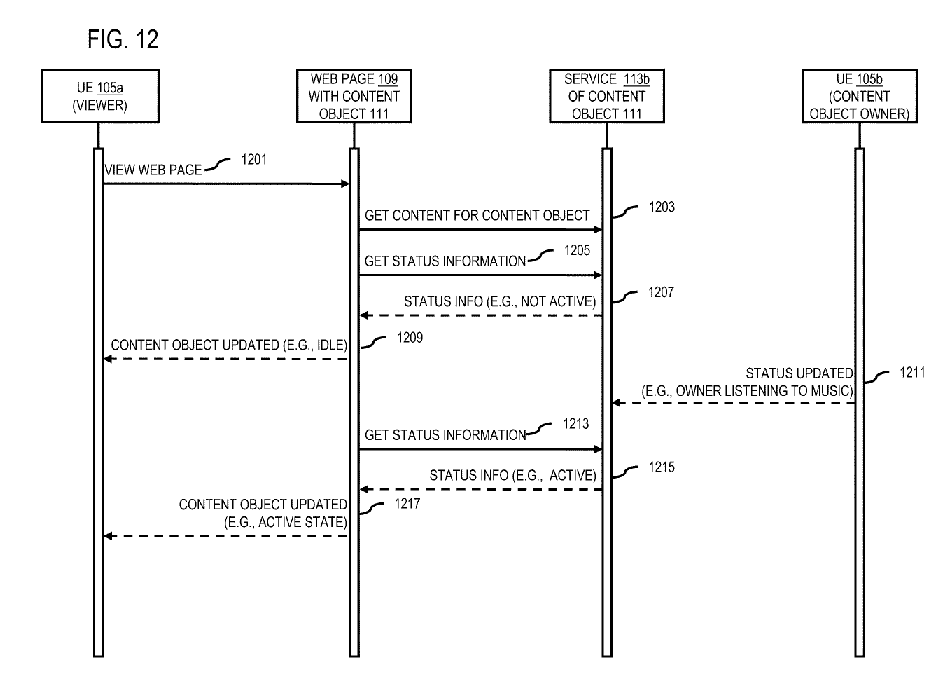

FIG. 12 is a time sequence diagram that illustrates a sequence of messages and processes for customizing a content object based on the status of the owner of the content object, according to one embodiment. A network process on the network is represented by a thin vertical box. A message passed from one process to another is represented by horizontal arrows. A step performed by a process is indicated by a box or looping arrow overlapping the process at a time sequence indicated by the vertical position of the box or looping arrow.

The processes represented in FIG. 12 are the UE 105a corresponding to the viewer, the web page 109 with embedded content object 111, the service 113b of the content object 111, and the UE 105b corresponding to the owner of the content object 111.

In the process 1201, the viewer via the UE 105a sends a request to browse a web page 109 embedded with the content object 111. On receipt of the browse request, the web page 109 initiates a request 1203 to the service 113b for content to present to the content object 111. At the same time, the web page 109 also sends a request 1205 for status information of the owner of the content object 111. In the example of FIG. 12, the owner had yet to provide a status update to the service 113b at the time the service 113b received the request from the UE 105a. Accordingly, the service 113b returns the default content to present the content object 111 along with status information to indicate that the owner is not active (at 1207). The web page 109 presents the received content in the content object 111 displayed on the UE 105a (at 1209).

In the meantime, the owner has entered an active state and updates his or her status in a message 1211 to the service 113b. For example, if the service 113b is a music service, the owner can update the status information to show that the owner is now listening to music. At a point after the owner's status is updated, the content object 111 of the web page 109 requests updated status information from the service 113b (at 1213). As discussed previously, the content object 111 may request status updates periodically, continuously, manually, on-demand, on detection of an update, or a combination thereof. The service 113b then provides the updated status information in a message 1215 to the content object 111 for presentation at the UE 105a (at 1217).

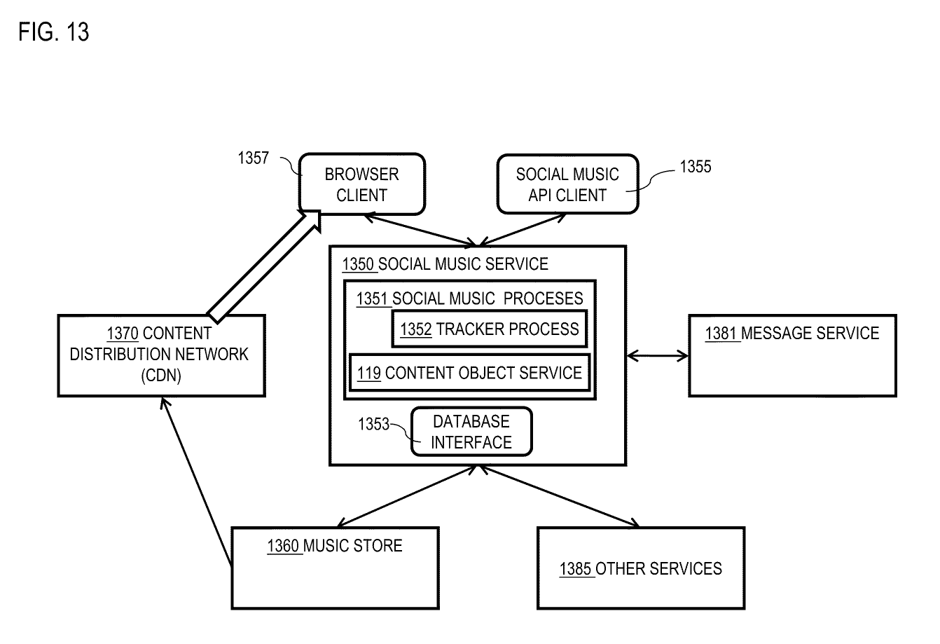

FIG. 13 is a diagram of components of a service, according to one embodiment. In the illustrated embodiment, the service 113 is a social music service 1350 and supports users in finding and playing music on their local devices (e.g., UEs 105) over the communication network 107. The social music service 1350 includes social music processes 1351 and a database interface process 1353. The social music processes 1351 are a set of applications (e.g., a Java™ stack written in the Java™ programming language that can be installed and executed on any device that includes a Java™ virtual machine (JVM) process). The social music processes 1351 include instructions for finding songs played by various users and metadata about songs and using the metadata to direct users to resources on the network where the user can sample, purchase or download those songs, alone or in some combination. The database interface process 1353 is the interface between the social music service 1350 and the content databases (not shown) available over the communication network 107; and is used to retrieve and store user information, metadata, and event data, and to retrieve and store content.

In the illustrated embodiment, the social music processes 1351 include played content tracker process 1352 to track played content and to use the database interface process 1353 to store and retrieve the event data that describes what is being played by whom and when. In the illustrated embodiment, the social music processes 1351 include a content object service 119.

According to the approach discussed herein, a content object 111 can be created to illustrate the taste or preferences of a content services user based on that person's content rendering list (i.e., playlist) or content rendering history (i.e., play history). For example, a content object 111 is created to illustrate the musical taste of a social music service client user based on that person's play list or play history. After the content object 111 is generated in the content object service 119 of the social music service 1350, the content object 111 can be emailed to other users in the particular user's social network or posted to a social network web page, such as a Facebook web page, or transferred via an instant messaging (IM) service or a web blog.

For example, a user operates a music content object 111 by interacting with the content object service 119 (directly or indirectly through a web page) in at least two ways. First, the user imports his or her play history (e.g., from last.fm, from yahoo music, or from some other music service). For example, in some embodiments, the user's musical profile is automatically collected from the music that the user listened to with that person's mobile phone (e.g., UE 105). Secondly, the user chooses one song as a theme song that best represents the user's musical taste, and populates the content object with multiple other songs selected from the user's play history. In many embodiments, the user also uploads to the content object 111 an image to represent the user's musical tastes, such as an image of the user or an image associated with the theme song.

For example, the content object service 119 implements a music content object 111 that will play a musical profile of the particular user as, for instance, clips of music on the particular user's playlist. The music content object 111 can be embedded in various social web pages or embedded in other messages. Any user in the social network may activate the content object 111 from the social network page (presented to a user via browser 121) or other message presentation client. The clips of content in the content object 111 can be played via the UE 105. In an example embodiment, the music content object 111 has direct access to a music store 1360 to enable the listener to purchase the song for the clip being played. Thus a user can show off the user's favorite tunes to friends in a social network or other network application. Furthermore, a user can discover and/or purchase one or more favorite songs of a friend in the user's social network or other network application.

In one embodiment, the social music service 1350 interacts with other processes on the network 107 using the hypertext transfer protocol (HTTP), often in concert with the Representational State Transfer (REST) constraints. The other processes may be on the same node or on different nodes.

In some embodiments, a user's device (e.g., UE 105) includes a service application 123 to interact with the social music service 1350, and a browser 121 to interact with web pages using HTTP. In some embodiments, interactions with the user can be through web pages and the user's browser 121; so that a separate service application 123 is omitted. The social music service 1350 interacts with one or more music store systems 1360, such as the NOKIA™ Music Store, to purchase songs to be downloaded to a user's device. The download is often accomplished using a Content Distribution Network (CDN) 1370. The music store 1360 authorizes the CDN 1370 to download to the client and then directs a link on the user's browser 121 to request the content from the CDN 1370. The content is delivered to the user through the user's browser 121 as data formatted, for example, according to HTTP or the real-time messaging protocol (RTMP) or the real-time streaming protocol (RTSP), all well known in the art. As a result, the content is stored as local content the user's device (e.g., UE 105). The local content arrives on the UE 105 either directly from the CDN 270, or indirectly through some other device or service (not shown).

In some embodiments, the social music service 1350 uses a message service 1381 to receive event data about playback events on the user's device. In some embodiments, the social music service 1350 uses other services 1385 (e.g., services 113a-113n) available on the network 107 such as people services to connect with other persons in a social music group of persons, mapping services to show a user's location and points of interest on a map, and gaming services to determine the user's status in one or more games.

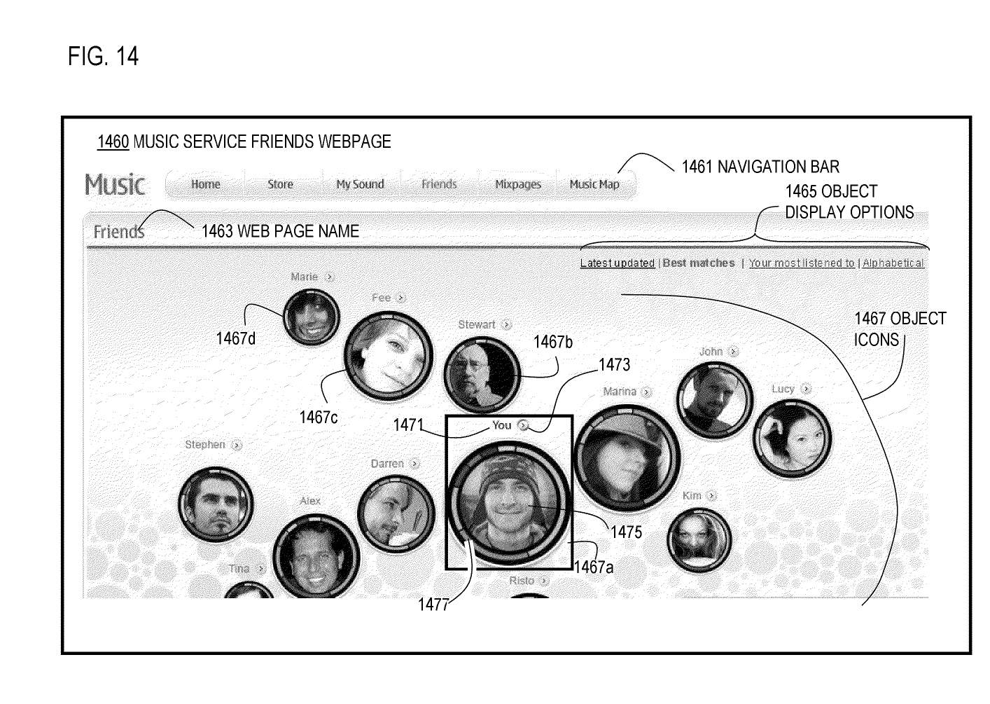

FIG. 14 is a diagram of an example web page with multiple content objects embedded thereon, according to an embodiment. The webpage 1460 is presented to a particular user of multiple registered users of a service 113 (e.g., a music service), and includes a navigation bar 1461, a web page name 1463, content object display options 1465, and one or more content object icons 1467.

The navigation bar 1461 includes active elements that can be selected by user input (e.g., via operation of a pointing device) to move among multiple web pages to be presented to the user, as is well known in the art. The web page name 1463 indicates the name for the web page currently presented to the particular user. It is assumed for purposes of illustration that the content objects of the particular user of the web page and the friends of the particular user of the webpage are presented on the web page named “Friends,” as shown.

The locket display options 1465 includes active elements that can be selected by user input (e.g., via operation of a pointing device) to chose among multiple different ways to present the content objects on the Friends web page. In the illustrated embodiment, the particular user can select among presentations that indicate: the friends' content objects most recently updated; the friends' content objects that most closely match the particular user's own playlist; the friends' content objects whose owners listen to them most; and alphabetical ordering of the friends' content objects.

As shown in FIG. 14, the content object icons 1467 are arranged to indicate the friends' content objects that most closely match the particular user's own playlist. The particular user's own content object icon 1467a is depicted along with the content object icons (e.g., content object icons 1467b, 1467c, 1467d) of friends of the particular user. Each content object icon 1467, such as content object icon 1467a, presents: a name 1471 of the content object owner; an active element 1473 to play content associated with the locket in response to input from the particular user; an image 1475; and a ring 1477 of content categories surrounding the image 1475. In the illustrated embodiment, the ring is color coded, with each color representing a different category of the content. For example, in social music content objects 111, the ring categories use different colors to represent each of classical, big band, folk, rhythm and blues, rock and roll, country, heavy metal, grunge, hip-hop, etc. By way of example, the percent of the ring colored for a particular category matches the percentage of the locket owner's playlist (or play history) that falls in the particular category.

In the illustrated embodiment, the degree of matching or similarity is indicated by the proximity of a friend's content object icon to the particular user's locket icon, with the best matches closest. The direction of the friend's content object indicates the category in which the best match occurs by the category on the particular user's ring intersected by a line segment that connects the two content object icons. The size of the content object icon indicates the size of the friend's playlist. Thus content object icon 1467b indicates a friend's playlist closest to the particular user for a category at 11 o'clock on the particular user's ring. The next match in such a category is a larger playlist indicated by content object icon 1467c, followed by a small playlist indicated by content object icon 1467d.

FIG. 15 is a flowchart of a process in a web server to use content objects 111, according to one embodiment. In step 1501, a request is received for a content service page. For example an HTTP get message is sent from a particular user's web browser with the particular user's authentication credentials, as a result of user input on a prior login page, to the web server 103 for the service platform 101. User authentication and authorization can be performed using well known techniques. In step 1503, a web page for the particular user is assembled, either dynamically or statically, based, for example, on the user credentials.

In step 1505, it is determined whether one or more content objects 111 are to be included in the web page. For example, it is determined whether the user is known, and if known, whether the user has registered with the service 113 of the content object 111. If not, then, during step 1507, the web page assembled in step 1503 is sent in one or more HTTP messages to the particular user's browser 121.

However, if it is determined in step 1505 that a content object 111 is to be included in the returned web page, the one or more content objects 111 are embedded in the web page during step 1511 and step 1519. In the illustrated embodiment, step 1511 to obtain content objects 111 includes steps 1513, 1515 and 1517.

In step 1513, an embed-content-object message is sent to the content object service 119. Any protocol may be used to send the embedded content object message. In an example embodiment, the embed-content-object message includes a type field that indicates the message type is an embed-content-object type and a user ID field. For example, the message is an HTTP Get message, well known in the art, with data indicating the embed-content-object type and a value for the user ID. In some embodiments, the content object service 119 has an application program interface (API) (not shown) and the embedded content object message from the web server 103 is a content object API client call to the content object service 119.

In response to the embed-content-object message, during step 1515, the web server 103 receives from the content object service 119 a content object 111 for the particular user. In step 1517, it is determined whether the content object 111 for another user is also to be embedded. For example, in an illustrated embodiment, the web server 103 also embeds the content objects of the friends of the particular user. The first locket received for the particular user indicates in field 211 the one or more user IDs of the friends of the particular user and/or the one or more social networks where the particular user is a member. This information is used by the web server 103 to send embed-content-object messages to the content object service 119 for each of the friends listed in field 211. When content objects 111 are received for all friends of the particular user, then the content objects 111 are included in the HTTP messages that build the web page in step 1519 and are sent in step 1507 to the particular user's browser 121. During step 1519, the content objects 111 are arranged on the web page in any manner, such as in the best matches order depicted in FIG. 14. The script in each content object controls the display of the individual content object icon on the particular user's web browser 121 when the one or more HTTP messages are received at the particular user's web browser 121. For example, the script generates a GUI that causes actions to be performed when the user interacts with the content object 111 in the user's browser 121.

When the particular user provides input to select an active element provided by the script of the content object 111, the script causes the browser 121 to send a content object event. The content object event indicates an event or action associated with the content indicated in the content object 111, based on the user input, for example rendering the content or causing other actions related to the content (e.g., identification determination). In various embodiments, the one or more active elements presented to the particular user in the browser 121, by the scripts provided in the content object 111, allow the particular user to perform one or more actions, such as rendering the theme content; rendering snippets of the play list; obtaining and rendering the complete content for one of the contents indicated in the playlist; pausing the rendering of the current content; stopping rendering of the current content; starting the rendering of the next content in the playlist; starting the rendering of the previous content indicated in the playlist, starting rendering the next content of the playlist in a particular category, starting rendering the content currently being rendered by the owner of the content object 111, requesting more information on the content, requesting supplemental content on the content, contacting the owner of the content object 111, or contacting a service provider to buy the content, among others, or some combination thereof.

In some embodiments, the content object event is sent from the browser 121 back to the web server 103, which forwards the content object event to the content object service 119. However, in other embodiments, the content object event is sent directly from the browser 121 to the content object service 119 or to other processes in the corresponding service 113. In some of these embodiments, the content object service 119 sends a notice of a content object event to the web server 103.

In response to receiving a content object event or notice thereof in step 1520, the web server 103 reports the content object event to the corresponding service 113 in step 1521. Thus a content object owner can determine from querying the service 113, how many times content from that owner's content object 111 has been rendered, or what content has been rendered, how often, what other actions have been taken, or what content has been bought, or some combination thereof. In some embodiments, no reporting is performed; and step 1521 is omitted.

In some embodiments, a modified HTTP message is formed in step 1523 based on the content object event or notice received in step 1520. For example, a new web page is generated that shows only the icon of the content object whose content is being rendered, or the art or other metadata associates with the content is displayed. For example, in various embodiments, when an active element (e.g., a content play command) for a friend's content object 111 is selected by the particular user, the presentation of the content object is modified; e.g., the icon is highlighted, a pause button or stop button or next button or previous button or theme button or current button or buy button or contact button or supplemental content button or information button, or some combination thereof, is superimposed or added on the locket, or the image is changed to the cover art of the content being rendered. The modified presentation is indicated in the revised HTTP message formed in step 1523 and sent to the particular user's web browser in step 1507. In some embodiments, all presentation changes associated with different actions available for the content object 111 are controlled by the scripts of the content object 111 and step 1523 is omitted.

In some embodiments, the web page presented to the particular user by the web browser provides an active element to edit or update the particular user's own content object 111, separate from the content object icons. Initial generation of a particular user's content object 111 can be performed this way. In such embodiments, the web server 103 receives an HTTP message that is not a content object event or notice thereof. In step 1525, it is determined whether such a message to create/edit/update a content object 111 is received, for example when the particular user wants to add or change the content object icon image or theme content (e.g., theme song) or remove one or more contents from the user's own playlist. If so, the updated content object information is obtained by the web server 103 and sent to the content object service 119 during step 1527 to update one or more values in the content object 111. In some embodiments, step 1527 involves presenting one or more web forms to the particular user to obtain the new or changed data. Web forms are well known in the art.

The web page is updated in step 1523 as a result of the input from the user; and sent to the particular user's web browser 121 in step 1507.

In step 1529, it is determined whether the process of supporting the content objects 111 should continue. If not, then the process ends. Otherwise, it is again determined in step 1520 and step 1525 whether a content object event or update is received. For example, when the web page receives no HTTP traffic for an extended period of time, e.g., 30 minutes, then it is determined in step 1529 to no longer continue, and the process ends.

FIG. 16 is a flowchart of a process at a content object or content object service to provide and render shared content, according to one embodiment. In step 1601, a request for a content object 111 owned by a user is received from an application, such as the web page server 163 which will embed the content object 111 in a web page or a web page client that is rendering the web page with the content object 111. In other embodiments, the request is received from some other application, such as a client or server of an email service, audio or video playback application, game application, map application, or IM or a music services process.

In step 1603 the content object 111 is initialized. In some embodiments, step 1603 includes updating the data of the content object 111, for example, based on one or more messages from the particular user, e.g., through one or more HTTP forms. In the illustrated embodiment, step 1603 includes steps 1605, 1607 and 1609. In step 1605, the user profile is obtained. For example, a database command is issued to get the user profile for the particular user from the user account database 117b in service platform 101. In the illustrated embodiment, the user's profile includes a list of the user IDs of the particular user's friends, according to at least some social network site. Some other user profile data, included in various embodiments, are recited above.

In step 1607, the user's playlist is obtained. For example, a database command is issued to get the user playlist for the particular user from the corresponding service 113. In the illustrated embodiment, the user's playlists includes a list of content IDs for content rendered by the particular user.

In step 1609, at least some metadata for the content identified in the particular user's playlist is obtained. For example, a database command is issued to get the metadata for one or more contents indicated in the user playlist for the particular user. In some embodiments, the metadata from one or more of the services 113 on the network 107. In the illustrated embodiment, the metadata includes, for instance, links to cover art for content in the particular user's playlist.

Based on the data obtained, e.g., in steps 1605, 1607 and 1609, the content object 111 is constructed. In some embodiments, the user's profile or the user's playlist indicates the theme content (e.g., theme song) that represents the particular user's style for the content.

In step 1611, the content object 111 is returned to the process that requested the content object 111 in step 1601, such as the web server 103. In embodiments in which the process is performed by the content object 111 itself, step 1611 merely augments the data and scripts already in the content object 111.

In step 1613, it is determined whether it is time to periodically check the current content being rendered by the particular user. If so, then the currently rendered content for the user is obtained in step 1615. For example, a database command is issued to get the event data for the particular user from the corresponding service 113. This event data 138 indicates the previously and currently rendered content detected at the UE 105 of the owner of the content object 111. If not, step 1615 is skipped.

In step 1617, it is determined whether a message indicating a user activated content object event has been received. In some embodiments, the content object event is received at the content object 111 embedded in the user's application. In some embodiments, such a content object event message is sent in response to user input by the script installed in the user's web browser 121 or other application by the content object 111, as described above. In some embodiments, the content object event is sent to the content object service 119. In some embodiments, the event is sent first to the web server 103 and relayed by the web server 103 to the content object service 119. The event can be sent by the owner of the content object 111 or by a different user for whom the owner is a friend on a social network. If a user activated content object event is not received in step 1617, then it is determined in step 1619 whether to wait and retry receiving a message in a little while, by repeating steps 1613 and 1617. If no retries are attempted, then the process ends.

If it is determined in step 1617, that a message indicating a user activated content object event has been received, then the action indicated by the content object event is performed in step 1621. In the illustrated embodiment, step 1621 includes step 1623 and step 1625. In step 1623, the content indicated in a play event message is streamed to the user's web browser 121. This may be done directly from the content object 111 or content object service 119 using content in from the service 113, or indirectly through a content distribution network (CDN) service 1370. Note that the user may be the owner of the content object 111 or a different user. If the user activated content object event indicates the content currently played by the content object 111 owner is desired by another user, then in step 1625, the content currently played is indicated to the user who activated the content object event. For example, the current content being played by the content object owner, as obtained in step 1615, is indicated in a message returned to the script process executing in the different user's browser 121.

In step 1627, the locket event received in step 1617 is indicated to the web server 103 or other application that requested the content object 111. In some embodiments, the web server 103 forwarded the user activated content object event and step 1627 is omitted. Control passes back to step 1613 and following steps to see if additional user activated content object events are received.

The processes described herein for protecting an embedded content object may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

FIG. 17 illustrates a computer system 1700 upon which an embodiment of the invention may be implemented. Although computer system 1700 is depicted with respect to a particular device or equipment, it is contemplated that other devices or equipment (e.g., network elements, servers, etc.) within FIG. 17 can deploy the illustrated hardware and components of system 1700. Computer system 1700 is programmed (e.g., via computer program code or instructions) to protect an embedded content object as described herein and includes a communication mechanism such as a bus 1710 for passing information between other internal and external components of the computer system 1700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1700, or a portion thereof, constitutes a means for performing one or more steps of protecting an embedded content object.

A bus 1710 includes one or more parallel conductors of information so that information is transferred quickly among devices coupled to the bus 1710. One or more processors 1702 for processing information are coupled with the bus 1710.

A processor 1702 performs a set of operations on information as specified by computer program code related to protect an embedded content object. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1710 and placing information on the bus 1710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1700 also includes a memory 1704 coupled to bus 1710. The memory 1704, such as a random access memory (RAM) or other dynamic storage device, stores information including processor instructions for protecting an embedded content object. Dynamic memory allows information stored therein to be changed by the computer system 1700. RAM allows a unit of information stored at a location called a memory address to be stored and retrieved independently of information at neighboring addresses. The memory 1704 is also used by the processor 1702 to store temporary values during execution of processor instructions. The computer system 1700 also includes a read only memory (ROM) 1706 or other static storage device coupled to the bus 1710 for storing static information, including instructions, that is not changed by the computer system 1700. Some memory is composed of volatile storage that loses the information stored thereon when power is lost. Also coupled to bus 1710 is a non-volatile (persistent) storage device 1708, such as a magnetic disk, optical disk or flash card, for storing information, including instructions, that persists even when the computer system 1700 is turned off or otherwise loses power.

Information, including instructions for protecting an embedded content object, is provided to the bus 1710 for use by the processor from an external input device 1712, such as a keyboard containing alphanumeric keys operated by a human user, or a sensor. A sensor detects conditions in its vicinity and transforms those detections into physical expression compatible with the measurable phenomenon used to represent information in computer system 1700. Other external devices coupled to bus 1710, used primarily for interacting with humans, include a display device 1714, such as a cathode ray tube (CRT) or a liquid crystal display (LCD), or plasma screen or printer for presenting text or images, and a pointing device 1716, such as a mouse or a trackball or cursor direction keys, or motion sensor, for controlling a position of a small cursor image presented on the display 1714 and issuing commands associated with graphical elements presented on the display 1714. In some embodiments, for example, in embodiments in which the computer system 1700 performs all functions automatically without human input, one or more of external input device 1712, display device 1714 and pointing device 1716 is omitted.

In the illustrated embodiment, special purpose hardware, such as an application specific integrated circuit (ASIC) 1720, is coupled to bus 1710. The special purpose hardware is configured to perform operations not performed by processor 1702 quickly enough for special purposes. Examples of application specific ICs include graphics accelerator cards for generating images for display 1714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1700 also includes one or more instances of a communications interface 1770 coupled to bus 1710. Communication interface 1770 provides a one-way or two-way communication coupling to a variety of external devices that operate with their own processors, such as printers, scanners and external disks. In general the coupling is with a network link 1778 that is connected to a local network 1780 to which a variety of external devices with their own processors are connected. For example, communication interface 1770 may be a parallel port or a serial port or a universal serial bus (USB) port on a personal computer. In some embodiments, communications interface 1770 is an integrated services digital network (ISDN) card or a digital subscriber line (DSL) card or a telephone modem that provides an information communication connection to a corresponding type of telephone line. In some embodiments, a communication interface 1770 is a cable modem that converts signals on bus 1710 into signals for a communication connection over a coaxial cable or into optical signals for a communication connection over a fiber optic cable. As another example, communications interface 1770 may be a local area network (LAN) card to provide a data communication connection to a compatible LAN, such as Ethernet. Wireless links may also be implemented. For wireless links, the communications interface 1770 sends or receives or both sends and receives electrical, acoustic or electromagnetic signals, including infrared and optical signals, that carry information streams, such as digital data. For example, in wireless handheld devices, such as mobile telephones like cell phones, the communications interface 1770 includes a radio band electromagnetic transmitter and receiver called a radio transceiver. In certain embodiments, the communications interface 1770 enables connection to the communication network 107 for protecting an embedded content object.

The term computer-readable medium is used herein to refer to any medium that participates in providing information to processor 1702, including instructions for execution. Such a medium may take many forms, including, but not limited to, non-volatile media, volatile media and transmission media. Non-volatile media include, for example, optical or magnetic disks, such as storage device 1708. Volatile media include, for example, dynamic memory 1704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1720.

Network link 1778 typically provides information communication using transmission media through one or more networks to other devices that use or process the information. For example, network link 1778 may provide a connection through local network 1780 to a host computer 1782 or to equipment 1784 operated by an Internet Service Provider (ISP). ISP equipment 1784 in turn provides data communication services through the public, world-wide packet-switching communication network of networks now commonly referred to as the Internet 1790.

A computer called a server host 1792 connected to the Internet hosts a process that provides a service in response to information received over the Internet. For example, server host 1792 hosts a process that provides information representing video data for presentation at display 1714. It is contemplated that the components of system 1700 can be deployed in various configurations within other computer systems, e.g., host 1782 and server 1792.

At least some embodiments of the invention are related to the use of computer system 1700 for implementing some or all of the techniques described herein. According to one embodiment of the invention, those techniques are performed by computer system 1700 in response to processor 1702 executing one or more sequences of one or more processor instructions contained in memory 1704. Such instructions, also called computer instructions, software and program code, may be read into memory 1704 from another computer-readable medium such as storage device 1708 or network link 1778. Execution of the sequences of instructions contained in memory 1704 causes processor 1702 to perform one or more of the method steps described herein. In alternative embodiments, hardware, such as ASIC 1720, may be used in place of or in combination with software to implement the invention. Thus, embodiments of the invention are not limited to any specific combination of hardware and software, unless otherwise explicitly stated herein.

The signals transmitted over network link 1778 and other networks through communications interface 1770, carry information to and from computer system 1700. Computer system 1700 can send and receive information, including program code, through the networks 1780, 1790 among others, through network link 1778 and communications interface 1770. In an example using the Internet 1790, a server host 1792 transmits program code for a particular application, requested by a message sent from computer 1700, through Internet 1790, ISP equipment 1784, local network 1780 and communications interface 1770. The received code may be executed by processor 1702 as it is received, or may be stored in memory 1704 or in storage device 1708 or other non-volatile storage for later execution, or both. In this manner, computer system 1700 may obtain application program code in the form of signals on a carrier wave.

Various forms of computer readable media may be involved in carrying one or more sequence of instructions or data or both to processor 1702 for execution. For example, instructions and data may initially be carried on a magnetic disk of a remote computer such as host 1782. The remote computer loads the instructions and data into its dynamic memory and sends the instructions and data over a telephone line using a modem. A modem local to the computer system 1700 receives the instructions and data on a telephone line and uses an infra-red transmitter to convert the instructions and data to a signal on an infra-red carrier wave serving as the network link 1778. An infrared detector serving as communications interface 1770 receives the instructions and data carried in the infrared signal and places information representing the instructions and data onto bus 1710. Bus 1710 carries the information to memory 1704 from which processor 1702 retrieves and executes the instructions using some of the data sent with the instructions. The instructions and data received in memory 1704 may optionally be stored on storage device 1708, either before or after execution by the processor 1702.

FIG. 18 illustrates a chip set 1800 upon which an embodiment of the invention may be implemented. Chip set 1800 is programmed to protect an embedded content object as described herein and includes, for instance, the processor and memory components described with respect to FIG. 17 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1800, or a portion thereof, constitutes a means for performing one or more steps of protecting an embedded content object.

In one embodiment, the chip set 1800 includes a communication mechanism such as a bus 1801 for passing information among the components of the chip set 1800. A processor 1803 has connectivity to the bus 1801 to execute instructions and process information stored in, for example, a memory 1805. The processor 1803 may include one or more processing cores with each core configured to perform independently. A multi-core processor enables multiprocessing within a single physical package. Examples of a multi-core processor include two, four, eight, or greater numbers of processing cores. Alternatively or in addition, the processor 1803 may include one or more microprocessors configured in tandem via the bus 1801 to enable independent execution of instructions, pipelining, and multithreading. The processor 1803 may also be accompanied with one or more specialized components to perform certain processing functions and tasks such as one or more digital signal processors (DSP) 1807, or one or more application-specific integrated circuits (ASIC) 1809. A DSP 1807 typically is configured to process real-world signals (e.g., sound) in real time independently of the processor 1803. Similarly, an ASIC 1809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1803 and accompanying components have connectivity to the memory 1805 via the bus 1801. The memory 1805 includes both dynamic memory (e.g., RAM, magnetic disk, writable optical disk, etc.) and static memory (e.g., ROM, CD-ROM, etc.) for storing executable instructions that when executed perform the inventive steps described herein to protect an embedded content object. The memory 1805 also stores the data associated with or generated by the execution of the inventive steps.

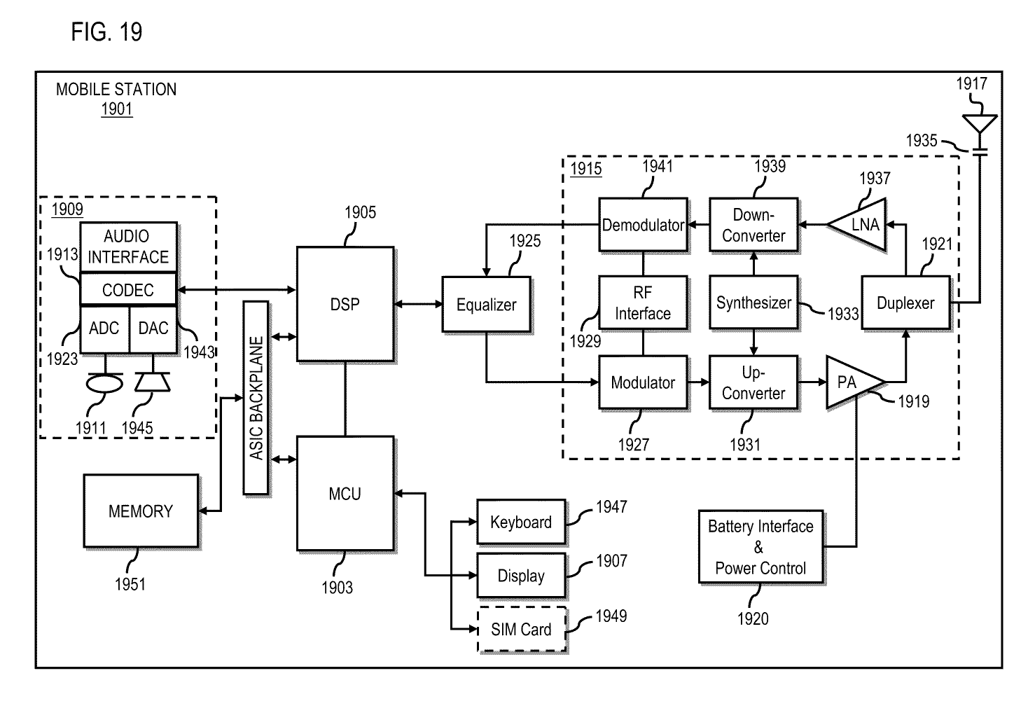

FIG. 19 is a diagram of exemplary components of a mobile terminal (e.g., handset) for communications, which is capable of operating in the system of FIG. 1, according to one embodiment. In some embodiments, mobile terminal 1900, or a portion thereof, constitutes a means for performing one or more steps of protecting an embedded content object. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1903, a Digital Signal Processor (DSP) 1905, and a receiver/transmitter unit including a microphone gain control unit and a speaker gain control unit. A main display unit 1907 provides a display to the user in support of various applications and mobile terminal functions that perform or support the steps of protecting an embedded content object. The display 19 includes display circuitry configured to display at least a portion of a user interface of the mobile terminal (e.g., mobile telephone). Additionally, the display 1907 and display circuitry are configured to facilitate user control of at least some functions of the mobile terminal. An audio function circuitry 1909 includes a microphone 1911 and microphone amplifier that amplifies the speech signal output from the microphone 1911. The amplified speech signal output from the microphone 1911 is fed to a coder/decoder (CODEC) 1913.

A radio section 1915 amplifies power and converts frequency in order to communicate with a base station, which is included in a mobile communication system, via antenna 1917. The power amplifier (PA) 1919 and the transmitter/modulation circuitry are operationally responsive to the MCU 1903, with an output from the PA 1919 coupled to the duplexer 1921 or circulator or antenna switch, as known in the art. The PA 1919 also couples to a battery interface and power control unit 1920.

In use, a user of mobile terminal 1901 speaks into the microphone 1911 and his or her voice along with any detected background noise is converted into an analog voltage. The analog voltage is then converted into a digital signal through the Analog to Digital Converter (ADC) 1923. The control unit 1903 routes the digital signal into the DSP 1905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1925 for compensation of any frequency-dependent impairments that occur during transmission though the air such as phase and amplitude distortion. After equalizing the bit stream, the modulator 1927 combines the signal with a RF signal generated in the RF interface 1929. The modulator 1927 generates a sine wave by way of frequency or phase modulation. In order to prepare the signal for transmission, an up-converter 1931 combines the sine wave output from the modulator 1927 with another sine wave generated by a synthesizer 1933 to achieve the desired frequency of transmission. The signal is then sent through a PA 1919 to increase the signal to an appropriate power level. In practical systems, the PA 1919 acts as a variable gain amplifier whose gain is controlled by the DSP 1905 from information received from a network base station. The signal is then filtered within the duplexer 1921 and optionally sent to an antenna coupler 1935 to match impedances to provide maximum power transfer. Finally, the signal is transmitted via antenna 1917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1901 are received via antenna 1917 and immediately amplified by a low noise amplifier (LNA) 1937. A down-converter 1939 lowers the carrier frequency while the demodulator 1941 strips away the RF leaving only a digital bit stream. The signal then goes through the equalizer 1925 and is processed by the DSP 1905. A Digital to Analog Converter (DAC) 1943 converts the signal and the resulting output is transmitted to the user through the speaker 1945, all under control of a Main Control Unit (MCU) 1903—which can be implemented as a Central Processing Unit (CPU) (not shown).

The MCU 1903 receives various signals including input signals from the keyboard 1947. The keyboard 1947 and/or the MCU 1903 in combination with other user input components (e.g., the microphone 1911) comprise a user interface circuitry for managing user input. The MCU 1903 runs a user interface software to facilitate user control of at least some functions of the mobile terminal 1901 to protect an embedded content object. The MCU 1903 also delivers a display command and a switch command to the display 1907 and to the speech output switching controller, respectively. Further, the MCU 1903 exchanges information with the DSP 1905 and can access an optionally incorporated SIM card 1949 and a memory 1951. In addition, the MCU 1903 executes various control functions required of the terminal. The DSP 1905 may, depending upon the implementation, perform any of a variety of conventional digital processing functions on the voice signals. Additionally, DSP 1905 determines the background noise level of the local environment from the signals detected by microphone 1911 and sets the gain of microphone 1911 to a level selected to compensate for the natural tendency of the user of the mobile terminal 1901.

The CODEC 1913 includes the ADC 1923 and DAC 1943. The memory 1951 stores various data including call incoming tone data and is capable of storing other data including music data received via, e.g., the global Internet. The software module could reside in RAM memory, flash memory, registers, or any other form of writable storage medium known in the art. The memory device 1951 may be, but not limited to, a single memory, CD, DVD, ROM, RAM, EEPROM, optical storage, or any other non-volatile storage medium capable of storing digital data.

An optionally incorporated SIM card 1949 carries, for instance, important information, such as the cellular phone number, the carrier supplying service, subscription details, and security information. The SIM card 1949 serves primarily to identify the mobile terminal 1901 on a radio network. The card 1949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving a request, from a device, for a content object embedding code;
in response to the request, causing, at least in part, actions that result in transmission of the content object embedding code including an unassociated binding key to the device, wherein the content object embedding code is embedded at a host;
detecting a first access of a content object corresponding to the content object embedding code at the host;
binding the content object to the host using the unassociated binding key in response to the detection.

2. A method of claim 1, wherein the content object has been bound to the host, and the method further comprising:
generating another unassociated binding key for a subsequent request for the content object embedding code.

3. A method of claim 1, further comprising:
storing an identifier of the host; and
including the identifier in a set of identifiers of other hosts that have been bound to the content object.

4. A method of claim 3, further comprising:
presenting the set of identifiers at the device;
receiving an input, from the device, for selecting one or more identifiers from the set of identifiers; and
removing the binding between one or more hosts corresponding to the one or more selected identifiers and the content object.

5. A method of claim 1, further comprising:
receiving a content request from the content object;
determining whether the content request originates from the host; and
causing, at least in part, actions that result in transmission of content to the content object based on the determination.

6. A method of claim 1, wherein the displayable medium includes a web page, an email message, a short message service (SMS) message, a multimedia messaging service (MMS) message, an instant messaging session, or a combination thereof

7. A method of claim 1, wherein the content object is related to a music service.

8. An apparatus comprising:
at least one processor; and
at least one memory including computer program code,
the at least one memory and the computer program code configured to, with the at least one processor, cause the apparatus to perform at least the following,
receive a request, from a device, for a content object embedding code;
in response to the request, cause, at least in part, actions that result in transmission of the content object embedding code including an unassociated binding key to the device, wherein the content object embedding code is embedded at a host;
detect a first access of a content object corresponding to the content object embedding code at the host;
bind the content object to the host using the unassociated binding key in response to the detection.

9. An apparatus of claim 8, wherein the content object has been bound to the host, and wherein the apparatus if further configured to:
generate another unassociated binding key for a subsequent request for the content object embedding code.

10. An apparatus of claim 8, wherein the apparatus is further configured to:
store an identifier of the host; and
include the identifier in a set of identifiers of other hosts that have been bound to the content object.

11. An apparatus of claim 10, wherein the apparatus is further configured to:
present the set of identifiers at the device;
receive an input, from the device, for selecting one or more identifiers from the set of identifiers; and
removing the binding between one or more hosts corresponding to the one or more selected identifiers and the content object.

12. An apparatus of claim 8, wherein the apparatus is further configured to:
receive a content request from the content object;
determine whether the content request originates from the host; and
cause, at least in part, actions that result in transmission of content to the content object based on the determination.

13. An apparatus of claim 8, wherein the displayable medium includes a web page, an email message, a short messaging service (SMS) message, a multimedia messaging service (MMS) message, an instant messaging session, or a combination thereof

14. An apparatus of claim 8, wherein the content object is related to a music service.

15. A computer-readable storage medium carrying one or more sequences of one or more instructions which, when executed by one or more processors, cause an apparatus to at least perform the following steps:
receiving a request, from a device, for a content object embedding code;
in response to the request, causing, at least in part, actions that result in transmission of the content object embedding code including an unassociated binding key to the device, wherein the content object embedding code is embedded at a host;
detecting a first access of a content object corresponding to the content object embedding code at the host;
binding the content object to the host using the unassociated binding key in response to the detection.

16. A computer readable storage medium of claim 15, wherein the content object has been bound to the host, and wherein the apparatus is further caused to perform:
generating another unassociated binding key for a subsequent request for the content object embedding code.

17. A computer readable storage medium of claim 15, wherein the apparatus is further caused to perform:
storing an identifier of the host; and
including the identifier in a set of identifiers of other hosts that have been bound to the content object.

18. A computer readable storage medium of claim 17, wherein the apparatus is further caused to perform:
presenting the set of identifiers at the device;
receiving an input, from the device, for selecting one or more identifiers from the set of identifiers; and
removing the binding between one or more hosts corresponding to the one or more selected identifiers and the content object.

19. A computer readable storage medium of claim 15, wherein the apparatus is further caused to perform:
receiving a content request from the content object;
determining whether the content request originates from the host; and
causing, at least in part, actions that result in transmission of content to the content object based on the determination.

20. A computer readable storage medium of claim 15, wherein the displayable medium includes a web page, an email message, a short messaging service (SMS) message, a multimedia messaging service (MMS) message, an instant messaging session, or a combination thereof, and wherein the content object is related to a music service.
